(19) United States
(12) Patent Application Publication
(10) Pub. No.: US 2022/0274432 A1
(43) Pub. Date: Sep. 1, 2022

(54) COMPOSITIONS AND METHODS FOR SENSITIZING HEAT MEDIA

(71) Applicant: SOLENIS TECHNOLOGIES, L.P., Wilmington, DE (US)

(72) Inventor: Erkan Kocak, Bezons (FR)

(73) Assignee: SOLENIS TECHNOLOGIES, L.P., Wilmington, DE (US)

(21) Appl. No.: 17/652,116

(22) Filed: Feb. 23, 2022

Related U.S. Application Data
(60) Provisional application No. 63/154,685, filed on Feb. 27, 2021.

(51) Int. Cl. B41M 5/337

(52) U.S. Cl. CPC B41M 5/3375

(57) ABSTRACT

A heat-sensitive recording composition and recording material. The recording material comprising a substrate, wherein a heat-sensitive composition comprising color formers, color developers and a sensitizer comprising a combination of ortho-toluenesulfonamide and para-toluenesulfonamide (OPTSA) is deposited onto the surface of the substrate.

### CROSS-REFERENCE TO RELATED APPLICATION

This application claims the benefit of U.S. Provisional application No. 63/154,685, filed Feb. 27, 2021, the entire contents of which are hereby incorporated by reference.

### TECHNICAL FIELD

Heat or thermally-responsive recording material comprising a support or substrate having provided thereon in substantially contiguous relationship in one or more layers a heat-sensitive coating comprising color formers, color developers and a sensitizer.

### BACKGROUND

Heat or thermo-sensitive recording materials such as thermal papers are well known and used in many applications such as point of sale (POS) receipts, tickets, tags, and labels.

Methods for manufacturing heat-sensitive recording materials are well known in the art. For example, at least one color former and at least one color developer, optionally at least one sensitizer, optionally at least one stabilizer and optionally at least one pigment are milled separately or in mixture in water or a compound with dispersing capabilities by means of a mill such as a bead mill, or like milling apparatus to form fine particle dispersions with an average particle diameter preferably in the range of 0.1 to 2.0 μm; more preferably of 0.3 to 1.0 μm.

In producing a heat-sensitive recording sheet, a composition or formulation containing the color former, usually an electron donor leuco dye, and the color developer (electron accepting compound) are applied to one or both surfaces of a base paper as a coating recording layer. When the coating is heated by a thermal printing head or laser, they are melted and mixed, reacting with each other to produce a developed record image.

For the purpose of improving recording speed and to obtain desired optical density at certain printing energy level, also called dynamic sensitivity, a sensitizer is used that has a lower melting point than the color developers and color formers. This reduces the amount of thermal energy needed to be applied on the heat-sensitive recording sheet for producing the desired image.

For this purpose, the relatively low melting point, the chemical affinity between the sensitizer, color developer and color former, and the viscosity of the melted material are parameters needed to dissolve the color former or the color developer and produce the desired image.

There is a continuing need to find a non-toxic, non-phenolic, non-ecotox, material which can improve the dynamic sensitivity of color developers, and more particularly of Pergafast™ 425, without negative side-effects on other qualities.

Furthermore, other desirable features and characteristics of the present disclosure will become apparent from the subsequent detailed description and the appended claims, taken in conjunction with the accompanying drawings and this background.

### BRIEF SUMMARY

A heat-sensitive recording composition is provided for. The composition comprising one or more color formers; one or more color developers; and at least one sensitizer comprising a mixture of ortho-toluenesulfonamide and para-toluenesulfonamide (OPTSA).

Also provided for is a method of producing heat-sensitive recording materials. The method includes providing a support or substrate that can optionally have one or more coating layers or undercoatings on one or both sides of the substrate. To the substrate or the one or more coatings layers on the substrate, one or more layers of a heat-sensitive recording composition is deposited or applied forming a heat-sensitive layer. The heat-sensitive recording composition comprises one or more color formers; one or more color developers; and at least one sensitizer comprising a mixture of ortho-toluenesulfonamide and para-toluenesulfonamides (OPTSA); thereby producing the recording material. In addition, one or more topcoat or protective layers may be deposited onto or applied on the heat-sensitive layer.

Finally, a recording sheet is provided for, wherein the recording sheet comprises a substrate or support and a recording composition disposed onto or applied to the substrate. The recording composition comprises one or more color formers; one or more color developers; and at least one sensitizer comprising a mixture of ortho-toluenesulfonamide and para-toluenesulfonamides (OPTSA).

### DETAILED DESCRIPTION

The following detailed description is merely exemplary in nature and is not intended to limit the present disclosure or the application and uses thereof. Furthermore, there is no intention to be bound by any theory presented in the preceding background or the following detailed description.

The heat-sensitive recording composition and embodiments herein can be used for any purpose as long as it is a recording material containing a color former, a color developer and a sensitizer as described herein, and for example, can be used as a thermal recording material.

In one aspect, the heat-sensitive recording compositions, also referred to as just the recording composition, heat-sensitive composition, includes one or more color formers, one or more color developers, and at least one sensitizer comprising a mixture of ortho-toluenesulfonamide and para-toluenesulfonamide (OPTSA).

In some aspects of the recording composition, the at least one sensitizer has a ratio of ortho-toluenesulfonamides to para-toluenesulfonamides is from about 0.5:99.5 to about 99.5:0.5, can be from about 5:90 to about 90:5, can be 10:85 to about 85:10, can be from about 20:80 to about 80:20, and maybe from about 40:60 to about 60:40, based on dry weight of the OPTSA mixture.

In other aspects of the recording composition, the at least one sensitizer is present in an amount of from about 0.1 to about 6 parts by dry mass per one part of the one or more color formers, can be in an amount of 0.5 to 5.0 parts by dry mass, and may be in an amount of 1.0 to 4.0 parts by dry mass.

In some aspects of the recording compositions, the one or more color developers of can include phenolic color developers, non-phenolic color developers and combinations thereof. For example, the one or more color developers can be chosen from 5-(N-3-methylphenyl-sulfonylamido)-(N′,N″-bis-(3-methylphenyl)-isophthalic acid diamide and [3-(p-tolylsulfonylcarbamoylamino)phenyl]4-methylbenzenesulfonate, 2.4′-dihydroxydiphenylsulfone, 4.4′-dihydroxydiphenylsulfone, bis-(3-allyl-4-hydroxyphenyl) sulfone, 4-[4′-[(1′-methylethyloxy)phenyl]sulfonyl]phenol, 4-hydroxyphenyl 4-isoprooxyphenyl sulfone, N-{2-[(phenylcarbamoyl)amino]phenyl} benzenesulfonamide, phenol, 4-[[4-(2-propenlyloxy)phenyl]sulfonyl, 4-Hydroxy-4′benzyloxydiphenylsulfone, and 4.4′bis(N-carbamoyl-4-methylbenzenesulfonamide) diphenylmethane, 4.4′-sulfonylbis-polymer with 1.1′-oxybis[2-chloroethane], phenols, urea urethane compounds and combinations thereof.

In yet other aspects of the recording composition, the color-developers can include bisphenol compounds such as bisphenol A, 4.4′-sec-butylidenebisphenol, 4.4′-cyclohexylidenebisphenol, 2.2′-bis(4-hydroxyphenyl)-3.3′-dimethylbutane, 2.2′-dihydroxydiphenyl, pentamethylene-bis(4-hydroxybenzoate), 2.2-dimethyl-3.3-di(4-hydroxyphenyl)pentane, 2.2-di(4-hydroxyphenyl)hexane, 2.2-bis(4-hydroxyphenyl)propane, 2.2-bis(4-hydroxyphenyl)butane, 2.2-bis(4-hydroxy-3-methylphenyl)propane, 4.4′-(1-phenylethylidene)bisphenol, 4.4′-ethylidenebisphenol, (hydroxyphenyl)methylphenol, 2.2′-bis(4-hydroxy-3-phenyl-phenyl)propane, 4.4′-(1.3-phenylenediisopropylidene)bisphenol, 4.4′-(1.4-phenylenediisopropylidene)bisphenol, and butyl 2.2-bis(4-hydroxyphenyl)acetate; sulfur-containing bisphenol compounds such as 4.4′-dihydroxydiphenyl thioether, 1.7-di(4-hydroxyphenylthio)-3.5-dioxaheptane, 2.2′-bis(4-hydroxyphenylthio)diethyl ether, and 4.4′-dihydroxy-3.3′-dimethyldiphenyl thioether; 4-hydroxybenzoic acid esters such as benzyl 4-hydroxybenzoate, ethyl 4-hydroxybenzoate, propyl 4-hydroxybenzoate, isopropyl 4-hydroxybenzoate, butyl 4-hydroxybenzoate, isobutyl 4-hydroxybenzoate, chlorobenzyl 4-hydroxybenzoate, methylbenzyl 4-hydroxybenzoate, and diphenylmethyl 4-hydroxybenzoate; metal salts of benzoic acid such as zinc benzoate and zinc 4-nitrobenzoate, salicylic acids such as 4-[2-(4-methoxyphenyloxy)ethyloxy]salicylic acid; metal salts of salicylic acid such as zinc salicylate and zinc bis[4-(octyloxycarbonylamino)-2-hydroxybenzoate]; hydroxysulfones such as 4.4′-dihydroxydiphenylsulfone, 2.4′-dihydroxydiphenylsulfone, 4-hydroxy-4′-methyldiphenylsulfone, 4-hydroxy-4′-isopropoxydiphenylsulfone, 4-hydroxy-4′-butoxydiphenylsulfone, 4.4′-dihydroxy-3.3′-diallyldiphenylsulfone, 3.4-dihydroxy-4′-methyldiphenylsulfone, 4.4′-dihydroxy-3.3′.5.5′-tetrabromodiphenylsulfone, 4-allyloxy-4′-hydroxydiphenylsulfone, 2-(4-hydroxyphenylsulfonyl)phenol, 4.4′-sulfonylbis[2-(2-propenyl)]phenol, 4-[[4-(propoxy)phenyl}sulfonyl]phenol, 4-[{4-(allyloxy)phenyl}sulfonyl]phenol, 4-[{4-(benzyloxy)phenyl}sulfonyl]phenol, and 2.4-bis(phenylsulfonyl)-5-methyl-phenol; 2.4′-dihydroxydiphenyl sulfone (BPS 2.4′), bis-(4hydroxyphenyl)sulfone (BPS 4.4′), bis(3-allyl-4-hydroxyphenyl)sulfone (TG-SA), B-TUM, SZ110, polyvalent metal salts of hydroxysulfones such as 4-phenylsulfonylphenoxy-zinc magnesium, -aluminum, and -titanium; 4-hydroxyphthalic acid diesters such as dimethyl 4-hydroxyphthalate, dicyclohexyl 4-hydroxyphthalate, and diphenyl 4-hydroxyphthalate; hydroxynaphthoic acid esters such as 2-hydroxy-6-carboxynaphthalene; trihalomethylsulfones such as tribromomethylphenylsulfone; sulfonylureas such as 4.4′-bis(p-toluenesulfonylamino carbonylamino)diphenylmethane and N-(4-methylphenylsulfonyl)-N′-(3-(4-methylphenylsulfonyloxy)phenyl)urea; hydroxyacetophenone, p-phenylphenol, benzyl 4-hydroxyphenylacetate, p-benzylphenol, hydroquinone-monobenzyl ether, 2.4-dihydroxy-2′-methoxybenzanilide, tetracyanoquinodimethanes, N-(2-hydroxyphenyl)-2-[(4-hydroxyphenyl)thio]acetamide, N-(4-hydroxyphenyl)-2-[(4-hydroxyphenyl)thio]acetamide, 4-hydroxybenzenesulfonanilide, 4′-hydroxy-4-methylbenzenesulfonanilide, 4.4′-bis(4-methyl-3-phenoxycarbonyl)aminophenylureido))diphenylsulfone, 3-(3-phenylureido)benzenesulfonanilide, octadecylphosphoric acid, and dodecylphosphoric acid; and cross-linked diphenylsulfone compounds represented by the following formula or mixtures thereof:

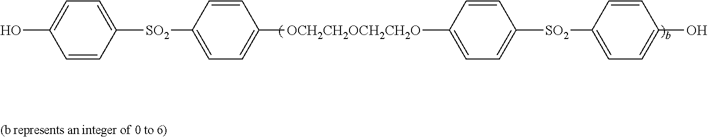

In some aspects of the recording composition, the one or more color formers can be fluoran, phthalide, lactam, triphenylmethane, phenothiazine, spiropyran leuco dyes and combinations thereof. For example, the one or more color formers can be 2-anilino-3-methyl-6-diethylaminofluorane, 2-anilino-3-methyl-6-dibutylaminofluorane, 2-anilino-3-methyl-6-(methyl-N-isoamylamino)fluorine, 2-anilino-3-methyl-6-(N-ethyl-N-propylamino)fluorane, 2-anilino-3-methyl-6-di-n-amylaminofluorane, 2-anilino-3-methyl-6-(N-ethyl-N-ptolylamino)fluorane, 2-anilino-3-methyl-6-N-ethyl-N-sec-butylaminofluorane, 3-di-(n-pentylamino)-6-methyl-7-anilinofluorane, 3-(N-isoamyl-N-ethylamino)-6-methyl-7-anilinofluorane, 3-(N-n-hexyl-N-ethylamino)-6-methyl-7-anilinofluorane, 3-[N-(3-ethoxypropyl)-N-ethylamino]-6-methyl-7-anilinofluorane, 3-di-(n-butylamino)-7-2-chloroanilino)fluorane, 3-diethylamino-7-(2-chloroanilino)fluorane, 3-(N-cyclohexyl-N-methylamino)-6-methyl-7-anilinofluorane and combinations thereof.

In still other aspects of the recording composition, the one or more color formers can be 3-diethylamino-6-methylfluoran, 3-dimethylamino-6-methyl-7-anilinofluoran, 3-diethylamino-6-methyl-7-anilinofluoran, 3-diethylamino-6-methyl-7-(2.4-dimethylanilino) fluoran, 3-diethylamino-6-methyl-7-chlorofluoran, 3-diethylamino-6-methyl-7-(3-trifluoromethylanilino) fluoran, 3-diethylamino-6-methyl-7-(2-chloroanilino)fluoran, 3-diethylamino-6-methyl-7-(4-chloroanilino) fluoran, 3-diethylamino-6-methyl-7-(2-fluoroanilino) fluoran, 3-diethylamino-6-methyl-7-(4-n-octylanilino) fluoran, 3-diethylamino-7-(4-n-octylanilino)fluoran, 3-diethylamino-7-(n-octylamino)fluoran, 3-diethylamino-7-(dibenzylamino)fluoran, 3-diethylamino-6-methyl-7-(dibenzylamino) fluoran, 3-diethylamino-6-chloro-7-methylfluoran, 3-diethylamino-7-t-butylfluoran, 3-diethylamino-7-carboxyethylfluoran, 3-diethylamino-6-chloro-7-anilinofluoran, 3-diethylamino-6-methyl-7-(3-methylanilino)fluoran, 3-diethylamino-6-methyl-7-(4-methylanilino)fluoran, 3-diethylamino-6-ethoxyethyl-7-anilinofluoran, 3-diethylamino-7-methylfluoran, 3-diethylamino-7-chlorofluoran, 3-diethylamino-7-(3-trifiuoromethylanilino)fluoran, 3-diethylamino-7-(2-chloroanilino)fluoran, 3-diethylamino-7-(2-fluoroanilino)fluoran, 3-diethylamino-benzo[a]fluoran, 3-diethylamino-benzo[c]fluoran, 3-dibutylamino-7-dibenzylaminofluoran, 3-dibutylamino-7-anilinofluoran, 3-diethyiamino-7-anilinofluoran, 3-dibutylamino-6-methylfluoran, 3-dibutylamino-6-methyl-7-anilinofluoran, 3-dibutylamino-6-methyl-7-(2.4-dimethylanilino)fluoran, 3-dibutytamino-6-methyl-7-(2-chloroanilino)fluoran, 3-dibutylamino-6-methyl-7-(4-chloroanilino)fluoran, 3-dibutylamino-6-methyl-7-(2-fluoroanitino)fluoran, 3-dibutylamino-6-methyl-7-(3-trifluoromethylanilino)fluoran, 3-dibutylamino-6-ethoxyethyl-7-anilinofluoran, 3-dibutylamino-6-chloro-anilinofluoran, 3-dibutylamino-6-methyl-7-(4-methylanilino)fluoran, 3-dibutylamino-7-(2-chloroanilino)fluoran, 3-dibutylamino-7-(2-fluoroanilino)fluoran, 3-dibutylamino-7-(N-methyl-N-formylamino)fluoran, 3-dipentylamino-6-methyl-7-anilinofluoran, 3-dipentylamino-6-methyl-7-(4-2-chloroanilino)fluoran, 3-dipentylamino-7-(3-trifluoromethylanilino)fluoran, 3-dipentylamino-6-chloro-7-anilinofluoran, 3-dipentylamino-7-(4-chloroanilino)fluoran, 3-pyrrolidino-6-methyl-7-anilinofluoran, 3-piperidino-6-methyl-7-anilinofluoran, 3-(N-methyl-N-propylamino)-6-methyl-7-anilinoftuoran, 3-(N-methyl-N-cyclohexylamino)-6-methyl-7-anilinofluoran, 3-(N-ethyl-N-cyclohexylamino)-6-methyl-7-anilinofluoran, 3-(N-ethyl-p-toluidino)-6-methyl-7-anilinofluoran, 3-(N-ethyl-N-isoamylamino)-6-methyl-7-anilinofluoran, 3-(N-ethyl-N-isoamylamino)-6-chloro-7-anilinofluoran, 3-(N-ethyl-N-tetrahydrofurfurylamino)-6-methyl-7-anilinofluoran, 3-(N-ethyl-N-isobutylamino)-6-methyl-7-anilinofluoran, 3-(N-butyl-N-isoamylamino)-6-methyl-7-anilinofluoran, 3-(N-isopropyl-N-3-pentylamino)-6-methyl-7-anilinofluoran, 3-(N-ethyl-N-ethoxypropylamino)-6-methyl-7-anilinofluoran, 3-cyclohexylamino-6-chlorofluoran, 2-methyl-6-p-(p-dimethytaminophenyl)aminoanilinofluoran, 2-methoxy-6-p-(p-dimethylaminophenyl) aminoanilinofluoran, 2-chloro-3-methyl-6-p-(p-phenylaminophenyl)aminoanilinofluoran, 2-diethylamino-6-p-(p-dimethylaminophenyl)aminoanilinofluoran, 2-phenyl-6-methyl-6-p-(p-phenylaminophenyl)aminoanilinofluoran, 2-benzyl-6-p-(p-phenylaminophenyl) aminoanilinofluoran, 3-methyl-6-p-(p-dimethylaminophenyl)amino-anilinofluoran, 3-diethylamino-6-p-(p-diethylaminophenyl)aminoanilinofluoran, 3-diethyl-amino-6-p-(p-dibutylaminophenyl)aminoanilinofluoran, 2.4-dimethyl-6-[(4-dimethylamino)-anilino]fluoran, 3-[(4-dimethylaminophenyl)amino]-5.7-dimethylfluoran, 3.6.6′-tris(dimethyl-amino)spiro[fluorene-9.3′-phthalide], 3.6.6′-tris(diethylamino)spiro[fluorene-9.3′-phthalide], 3.3-bis(p-dimethylaminophenyl)-6-dimethylaminophthalide, 3.3-bis(p-dimethylamino-phenyl)phthalide, 3.3-bis-[2-(p-dimethylaminophenyl)-2-(p-methoxyphenyl)ethenyl-4.5.6.7-tetrabromophthalide, 3.3-bis-[2-(p-dimethylaminophenyl)-2-(p-methoxyphenyl)ethenyl-4.5.6.7-tetrachlorophthalide, 3.3-bis[1.1-bis(4-pyrrolidinophenyl)ethylene-2-yl]-4.5.6.7-tetrabromophthalide, 3.3-bis-(1-(4-methoxyphenyl)-1-(4-pyrridinophenyl)ethylene-2-yl]-4.5.6.7-tetrachlorophthalide, 3-(4-diethylamino-2-ethoxyphenyl)-3-(1-ethyl-2-methylindole-3-yl)-4-azaphthalide, 3-(4-diethylamino-2-ethoxyphenyl)-3-(1-octyl-2-methylindole-3-yl)-4-azaphthalide, 3-(4-cyclohexylethylamino-2-methoxyphenyl)-3-(1-ethyl-2-methylindole-3-yl)-4-azaphthalide, 3.3-bis(1-ethyl-2-methylindole-3-yl)phthalide, 3.3-bis(1-octyl-2-methylindole-3-yl)phthalide, mixture of 2-phenyl-4-(4-diethylaminophenyl)-4-(4-methoxyphenyl)-6-methyl-7-dimethylamino-3.1-benzoxazine and 2-phenyl-4-(4-diethylaminophenyl)-4-(4-methoxyphenyl)-8-methyl-7-dimethylamino-3.1-benzoxazine, 4.4′-[1-methylethylidene)-bis(4.1-phenyleneoxy-4.2-quinazolinediyl)]bis[N,N-diethylbenzenamine], bis(N-methyldiphenylamine)-4-yl-(N-butylcarbazole)-3-yl-methane and combinations thereof.

In yet other aspects of the recording composition, the color formers can be 3-diethylamino-6-methyl-7-anilinofluoran, 3-diethylamino-6-methyl-7-(3-methylanilino)fluoran, 3-diethylamino-6-methyl-7-(2.4-dimethylanilino)fluoran, 3-dibutylamino-6-methyl-7-anilinofluoran, 3-dipentylamino-6-methyl-7-anilinofluoran, 3-(N-methyl-N-propylamino)-6-methyl-7-anilinofluoran, 3-(N-methyl-N-cyclohexylamino)-6-methyl-7-anilinofluoran, 3-(N-ethyl-N-isoamylamino)-6-methyl-7-anilinofluoran, 3-diethylamino-6-chloro-7-anilinofluoran, 3-dibutylamino-7-(2-chloroanilino)fluoran, 3-N-ethyl-p-toluidino-6-methyl-7-anilinofluoran, 3-(N-ethyl-N-tetrahydrofurfurylamino)-6-methyl-7-anilinofluoran, 3-(N-ethyl-N-isobutylamino)-6-methyl-7-anilinofluoran, 3-N-ethyl-N-ethoxypropylamino-6-methyl-7-anilinofluoran, 2.4-dimethyl-6-[(4-dimethylamino) anilino]fluoran, 3-(4-diethylamino-2-ethoxyphenyl)-3-(1-octyl-2-methylindole-3yl)-4-azaphthalide, 3.3-bis(p-dimethylamino-phenyl)-6-dimethytaminophthalide and mixtures thereof. It is also possible to use solid solutions comprising at least two color formers or color forming compounds.

In some aspects of the recording composition, the color formers can be used singly or as a mixture with other color formers; or they may also be used together with further black color formers or color forming compounds.

In yet other aspects of the recording composition, the composition can further include image stabilizers, sensitizers, fillers, binders, dispersants, antioxidants, anti-tack agents, desensitizers, antifoaming agents, light stabilizers, fluorescent brightening agents and combinations thereof.

In some aspects of the recording composition, the composition can include one or more sensitizers in addition to the OPTSA. For example, additional sensitizers can include: higher fatty acid amides such as stearic acid amide, stearic acid anilide, and palmitic acid amide; amides such as benzamide, acetoacetic acid anilide, thioacetanilide acrylic acid amide, ethylenebisamide, ortho-toluenesulfonamide, and para-toluenesulfonamide; phthalic acid diesters such as dimethyl phthalate, dibenzyl isophthalate, dimethyl isophthalate, dimethyl terephthalate, diethyl isophthalate, diphenyl isophthalate, and dibenzyl terephthalate; oxalic acid diesters such as dibenzyl oxalate, di(4-methylbenzyl)oxalate, di(4-chlorobenzyl)oxalate, a mixture of dibenzyl oxalate and di(4-chlorobenzyl)oxalate in equal amounts, and a mixture of di(4-chlorobenzyl)oxalate and di(4-methylbenzyl)oxalate in equal amounts; bis(t-butylphenols) such as 2.2′-methylenebis(4-methyl-6-t-butylphenol) and 4.4′-methylene-bis-2.6-di-t-butylphenol; 4.4′-dihydroxydiphenylsulfone diethers such as 4.4′-dimethoxydiphenylsulfone, 4.4′-diethoxydiphenylsulfone, 4.4′-dipropoxydiphenylsulfone, 4.4′-diisopropoxydiphenylsulfone, 4.4′-dibutoxydiphenylsulfone, 4.4′-diisobutoxydiphenyl sulfone, 4.4′-dipentyloxydiphenylsulfone, 4.4′-dihexyloxydiphenylsulfone, and 4.4′-diallyloxydiphenylsulfone; 2.4′-dihydroxydiphenylsulfone diethers such as 2.4′-dimethoxydiphenylsulfone, 2.4′-diethoxydiphenylsulfone, 2.4′-dipropoxydiphenylsulfone, 2.4′-diisopropoxydiphenylsulfone, 2.4′-dibutoxydiphenylsulfone, 2.4′-diisobutoxydiphenyl sulfone, 2.4′-dipentyloxydiphenylsulfone, 2.4′-dihexyloxydiphenylsulfone, and 2.4′-diallyloxydiphenylsulfone; 1.2-bis(phenoxy)ethane, 1.2-bis(4-methylphenoxy)ethane, 1.2-bis(3-methylphenoxy)ethane, 1.2-bis(phenoxymethyl)benzene, 1.2-bis(4-methoxyphenylthio)ethane, 1.2-bis(4-methoxyphenoxy)propane, 1.3-phenoxy-2-propanol, 1.4-diphenylthio-2-butene, 1.4-diphenylthiobutane, 1.4-diphenoxy-2-butene, 1.5-bis(4-methoxyphenoxy)-3-oxapentane, 1.3-dibenzoyloxypropane, dibenzoyloxymethane, 4.4′-ethylenedioxy-bis-benzoic acid dibenzyl ester, bis[2-(4-methoxy-phenoxy)ethyl]ether, 2-naphthylbenzyl ether, 1.3-bis(2-vinyloxyethoxy)benzene, 1.4-diethoxynaphthalene, 1.4-dibenzyloxynaphthalene, 1.4-dimethoxynaphthalene, 1.4-bis(2-vinyloxyethoxy)benzene, p-(2-vinyloxyethoxy) biphenyl, p-aryloxybiphenyl, p-propargyloxybiphenyl, p-benzyloxy benzyl alcohol, 4-(m-methylphenoxymethyl)biphenyl, 4-methylphenyl-biphenyl ether, di-β-naphthylphenylenediamine, diphenylamine, carbazole, 2.3-di-m-tolylbutane, 4-benzyl biphenyl, 4.4′-dimethylbiphenyl, terphenyls such as m-terphenyl and p-terphenyl; 1.2-bis(3.4-dimethylphenyl)ethane, 2.3.5.6-tetramethyl-4′-methyldiphenylmethane, 4-acetyl biphenyl, dibenzoylmethane, triphenylmethane, phenyl 1-hydroxy-naphthoate, methyl 1-hydroxy-2-naphthoate, N-octadecylcarbamoyl-p-methoxycarbonylbenzene, benzyl p-benzyloxybenzoate, phenyl β-naphthoate, methyl p-nitrobenzoate, diphenylsulfone, carbonic acid derivatives such as diphenyl carbonate, guaiacol carbonate, di-p-tolyl carbonate, and phenyl-α-naphthyl carbonate; 1.1-diphenylpropanol, 1.1-diphenylethanol, N-octadecyl carbamoylbenzene, dibenzyl disulfide, stearic acid, Amide AP-1 (7:3 mixture of stearic acid amide and palmitic acid amide), stearates such as aluminum stearate, calcium stearate, and zinc stearate; and zinc palmitate, behenic acid, zinc behenate, montanic acid wax, polyethylene wax, and combinations thereof.

The recording composition so obtained can be applied to a suitable support or substrate such as paper, plastic sheet, and resin coated paper, and used as a heat-sensitive recording material. Embodiments herein can be employed for other end use applications using color forming materials, for example, a temperature indicating material. As used herein, the terms substrate and support are used interchangeably.

A method of producing a heat-sensitive recording material is also provided for. The method includes providing a support or substrate, depositing or applying one or more layers or coatings of a heat-sensitive recording composition, which is deposited onto or applied to the substrate, thereby forming the heat-sensitive layer; and thereby producing the heat-sensitive recording material. The heat-sensitive recording composition comprises one or more color formers; one or more color developers; and at least one sensitizer comprising a mixture of ortho-toluenesulfonamide and para-toluenesulfonamides (OPTSA).

In some aspects of the method, the at least one sensitizer of the recording composition has a ratio of ortho-toluenesulfonamides to para-toluenesulfonamides is from about 0.5:99.5 to about 99.5:0.5, can be from about 5:90 to about 90:5, can be 10:85 to about 85:10, can be from about 20:80 to about 80:20, and maybe from about 40:60 to about 60:40, based on dry weight of the OPTSA mixture.

In other aspects of the method, the at least one sensitizer is present in an amount of from about 0.1 to about 6 parts by dry mass per one part of the one or more color formers, can be in an amount of 0.5 to 5.0 parts by dry mass, and may be in an amount of 1.0 to 4.0 parts by dry mass.

In some aspects of the method, an undercoat layer can be deposited onto or applied to the substrate prior to the deposition of the heat-sensitive recording composition. An undercoat generally contains as its main components a binder resin and a filler. For example, the binder resins in the undercoat layer can be polyvinyl alcohol; starch and starch derivatives; cellulose derivatives such as methoxycellulose, hydroxyethylcellulose, carboxymethyl cellulose, methylcellulose and ethylcellulose; sodium polyacrylate; polyvinyl pyrrolidone; polyacrylamide/acrylic acid ester copolymers; acrylamide/acrylic acid ester/methacrylic acid copolymers; alkali metal salts of styrene/maleic anhydride copolymers; alkali metal salts of isobutylene/maleic anhydride copolymers; polyacrylamide; sodium alginate; gelatin; casein; water-soluble polymers such as water-soluble polyesters and carboxyl-group-modified polyvinyl alcohols; polyvinyl acetate; polyurethanes; styrene/butadiene copolymers; polyacrylic acid; polyacrylic acid esters; vinyl chloride/vinyl acetate copolymers; polybutylmethacrylate; ethylene/vinylacetate copolymers and styrene/butadiene acrylic derivative copolymers.

In other aspects of the method, the undercoat layer can be finely-divided inorganic powders, e.g. of calcium carbonate, silica, zinc oxide, titanium oxide, aluminum hydroxide, zinc hydroxide, barium sulphate, clay, talc, surface-treated calcium, silica or calcined clay (e.g. Ansilex, Engelhard Corp.), and finely-divided organic powders of, e.g., urea-formaldehyde resins, styrene/methacrylic acid copolymers, polystyrene and combinations thereof. The undercoat layer may also contain a water-resisting agent.

In other aspects of the method, one or more top coatings or protective layers can be deposited onto or applied to the one or more heat-sensitive recording composition layers. Whereas the undercoat layer is interposed between the substrate and the heat-sensitive composition, the topcoat or protective layer is dispersed onto or applied to the heat-sensitive composition layer. The topcoat can include a water-soluble resin in order to protect the heat-sensitive composition layer. If desired, the topcoat layer may contain water-soluble resins in combination with water-insoluble resins, such as polyvinyl alcohol; starch and starch derivatives; cellulose derivatives such as methoxycellulose, hydroxyethylcellulose, carboxymethylcellulose, methylcellulose and ethylcellulose; sodium polyacrylate; polyvinyl pyrrolidone; polyacrylamide/acrylic acid ester copolymers; acrylamide/acrylic acid ester/methacrylic acid copolymers; alkali metal salts of styrene/maleic anhydride copolymers; alkali metal salts of isobutylene/maleic anhydride copolymers; polyacrylamide; sodium alginate; gelatin; casein; water-soluble polyesters and carboxyl-group-modified polyvinyl alcohols and combinations thereof.

In other aspects of the method, the topcoat layer may contain a water-resisting agent such as a polyamide resin, melamine resin, formaldehyde, glyoxal or chromium alum. The topcoat layer may contain fillers, such as finely-divided inorganic powders, e.g. of calcium carbonate, silica, zinc oxide, titanium oxide, aluminum hydroxide, zinc hydroxide, barium sulphate, clay, talc, surface-treated calcium or silica, or a finely-divided organic powder of, e.g., a urea-formaldehyde resin, a styrene/methacrylic acid copolymer or polystyrene, and combinations thereof.

In some aspects of the method, the one or more color developers of the recording composition can include phenolic color developers, non-phenolic color developers and combinations thereof. For example, the one or more color developers can be chosen from 5-(N-3-methylphenyl-sulfonylamido)-(N′,N″-bis-(3-methylphenyl)-isophthalic acid diamide and [3-(p-tolylsulfonylcarbamoylamino)phenyl]4-methylbenzenesulfonate, 2.4′-dihydroxydiphenylsulfone, 4.4′-dihydroxydiphenylsulfone, bis-(3-allyl-4-hydroxyphenyl) sulfone, 4-[4′-[(1′-methylethyloxy)phenyl]sulfonyl]phenol, 4-hydroxyphenyl 4-isoprooxyphenyl sulfone, N-{2-[(phenylcarbamoyl)amino]phenyl} benzenesulfonamide, phenol, 4-[[4-(2-propenlyloxy)phenyl]sulfonyl, 4-Hydroxy-4′benzyloxydiphenylsulfone, and 4.4′bis(N-carbamoyl-4-methylbenzenesulfonamide) diphenylmethane, 4.4′-sulfonylbis-polymer with 1.1′-oxybis[2-chloroethane], phenols, urea urethane compounds and combinations thereof.

In yet other aspects of the method, the color-developers of the heat-sensitive composition can include bisphenol compounds such as bisphenol A, 4.4′-sec-butylidenebisphenol, 4.4′-cyclohexylidenebisphenol, 2.2′-bis(4-hydroxyphenyl)-3.3′-dimethylbutane, 2.2′-dihydroxydiphenyl, pentamethylene-bis(4-hydroxybenzoate), 2.2-dimethyl-3.3-di(4-hydroxyphenyl)pentane, 2.2-di(4-hydroxyphenyl)hexane, 2.2-bis(4-hydroxyphenyl)propane, 2.2-bis(4-hydroxyphenyl)butane, 2.2-bis(4-hydroxy-3-methylphenyl)propane, 4.4′-(1-phenylethylidene)bisphenol, 4.4′-ethylidenebisphenol, (hydroxyphenyl)methylphenol, 2.2′-bis(4-hydroxy-3-phenyl-phenyl)propane, 4.4′-(1.3-phenylenediisopropylidene)bisphenol, 4.4′-(1.4-phenylenediisopropylidene)bisphenol, and butyl 2.2-bis(4-hydroxyphenyl)acetate; sulfur-containing bisphenol compounds such as 4.4′-dihydroxydiphenyl thioether, 1.7-di(4-hydroxyphenylthio)-3.5-dioxaheptane, 2.2′-bis(4-hydroxyphenylthio)diethyl ether, and 4.4′-dihydroxy-3.3′-dimethyldiphenyl thioether; 4-hydroxybenzoic acid esters such as benzyl 4-hydroxybenzoate, ethyl 4-hydroxybenzoate, propyl 4-hydroxybenzoate, isopropyl 4-hydroxybenzoate, butyl 4-hydroxybenzoate, isobutyl 4-hydroxybenzoate, chlorobenzyl 4-hydroxybenzoate, methylbenzyl 4-hydroxybenzoate, and diphenylmethyl 4-hydroxybenzoate; metal salts of benzoic acid such as zinc benzoate and zinc 4-nitrobenzoate, salicylic acids such as 4-[2-(4-methoxyphenyloxy)ethyloxy] salicylic acid; metal salts of salicylic acid such as zinc salicylate and zinc bis[4-(octyloxycarbonylamino)-2-hydroxybenzoate]; hydroxysulfones such as 4.4′-dihydroxy diphenylsulfone, 2.4′-dihydroxydiphenylsulfone, 4-hydroxy-4′-methyldiphenylsulfone, 4-hydroxy-4′-isopropoxydiphenylsulfone, 4-hydroxy-4′-butoxydiphenylsulfone, 4.4′-dihydroxy-3.3′-diallyldiphenylsulfone, 3.4-dihydroxy-4′-methyldiphenylsulfone, 4.4′-dihydroxy-3.3′.5.5′-tetrabromodiphenylsulfone, 4-allyloxy-4′-hydroxydiphenylsulfone, 2-(4-hydroxyphenylsulfonyl)phenol, 4.4′-sulfonylbis[2-(2-propenyl)]phenol, 4-[[4-(propoxy)phenyl}sulfonyl]phenol, 4-[{4-(allyloxy)phenyl}sulfonyl]phenol, 4-[{4-(benzyloxy)phenyl}sulfonyl]phenol, and 2.4-bis(phenylsulfonyl)-5-methyl-phenol; 2.4′-dihydroxydiphenyl sulfone (BPS 2.4′), bis-(4hydroxyphenyl)sulfone (BPS 4.4′), bis(3-allyl-4-hydroxyphenyl)sulfone (TG-SA), B-TUM, SZ110, polyvalent metal salts of hydroxysulfones such as 4-phenylsulfonylphenoxy-zinc magnesium, -aluminum, and -titanium; 4-hydroxyphthalic acid diesters such as dimethyl 4-hydroxyphthalate, dicyclohexyl 4-hydroxyphthalate, and diphenyl 4-hydroxyphthalate; hydroxynaphthoic acid esters such as 2-hydroxy-6-carboxynaphthalene; trihalomethylsulfones such as tribromomethylphenylsulfone; sulfonylureas such as 4.4′-bis(p-toluenesulfonylamino carbonylamino)diphenylmethane and N-(4-methylphenylsulfonyl)-N′-(3-(4-methylphenylsulfonyloxy)phenyl)urea; hydroxyacetophenone, p-phenylphenol, benzyl 4-hydroxyphenylacetate, p-benzylphenol, hydroquinone-monobenzyl ether, 2.4-dihydroxy-2′-methoxybenzanilide, tetracyanoquinodimethanes, N-(2-hydroxyphenyl)-2-[(4-hydroxyphenyl)thio]acetamide, N-(4-hydroxyphenyl)-2-[(4-hydroxyphenyl)thio]acetamide, 4-hydroxybenzenesulfonanilide, 4′-hydroxy-4-methylbenzenesulfonanilide, 4.4′-bis(4-methyl-3-phenoxycarbonyl)aminophenylureido))diphenylsulfone, 3-(3-phenylureido)benzenesulfonanilide, octadecylphosphoric acid, and dodecylphosphoric acid; and cross-linked diphenylsulfone compounds represented by the following formula or mixtures thereof:

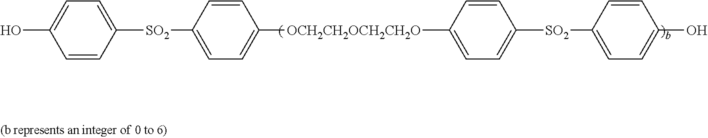

In some aspects of the method, the one or more color formers of the heat-sensitive composition can be fluoran, phthalide, lactam, triphenylmethane, phenothiazine, spiropyran leuco dyes and combinations thereof. For example, the one or more color formers is chosen from 2-anilino-3-methyl-6-diethylaminofluorane, 2-anilino-3-methyl-6-dibutylamino fluorane, 2-anilino-3-methyl-6-(methyl-N-isoamylamino)fluorine, 2-anilino-3-methyl-6-(N-ethyl-N-propylamino)fluorane, 2-anilino-3-methyl-6-di-n-amylaminofluorane, 2-anilino-3-methyl-6-(N-ethyl-N-ptolylamino)fluorane, 2-anilino-3-methyl-6-N-ethyl-N-sec-butylaminofluorane, 3-di-(n-pentylamino)-6-methyl-7-anilinofluorane, 3-(N-isoamyl-N-ethylamino)-6-methyl-7-anilinofluorane, 3-(N-n-hexyl-N-ethylamino)-6-methyl-7-anilinofluorane, 3-[N-(3-ethoxypropyl)-N-ethylamino]-6-methyl-7-anilinofluorane, 3-di-(n-butylamino)-7-2-chloroanilino)fluorane, 3-diethylamino-7-(2-chloroanilino)fluorane, 3-(N-cyclohexyl-N-methylamino)-6-methyl-7-anilinofluorane, or combinations thereof.

In still other aspects of the method, the one or more color formers include, but are not limited to, 3-diethylamino-6-methylfluoran, 3-dimethylamino-6-methyl-7-anilinofluoran, 3-diethylamino-6-methyl-7-anilinofluoran, 3-diethylamino-6-methyl-7-(2.4-dimethylanilino) fluoran, 3-diethylamino-6-methyl-7-chlorofluoran, 3-diethylamino-6-methyl-7-(3-trifluoromethylanilino) fluoran, 3-diethylamino-6-methyl-7-(2-chloroanilino) fluoran, 3-diethylamino-6-methyl-7-(4-chloroanilino) fluoran, 3-diethylamino-6-methyl-7-(2-fluoroanilino) fluoran, 3-diethylamino-6-methyl-7-(4-n-octylanilino) fluoran, 3-diethylamino-7-(4-n-octylanilino)fluoran, 3-diethylamino-7-(n-octylamino)fluoran, 3-diethylamino-7-(dibenzylamino)fluoran, 3-diethylamino-6-methyl-7-(dibenzylamino) fluoran, 3-diethylamino-6-chloro-7-methylfluoran, 3-diethylamino-7-t-butylfluoran, 3-diethylamino-7-carboxyethylfluoran, 3-diethylamino-6-chloro-7-anilinofluoran, 3-diethylamino-6-methyl-7-(3-methylanilino)fluoran, 3-diethylamino-6-methyl-7-(4-methylanilino)fluoran, 3-diethylamino-6-ethoxyethyl-7-anilinofluoran, 3-diethylamino-7-methylfluoran, 3-diethylamino-7-chlorofluoran, 3-diethylamino-7-(3-trifiuoromethylanilino) fluoran, 3-diethylamino-7-(2-chloroanilino)fluoran, 3-diethylamino-7-(2-fluoroanilino) fluoran, 3-diethylamino-benzo[a]fluoran, 3-diethylamino-benzo[c]fluoran, 3-dibutylamino-7-dibenzylaminofluoran, 3-dibutylamino-7-anilinofluoran, 3-diethyiamino-7-anilinofluoran, 3-dibutylamino-6-methylfluoran, 3-dibutylamino-6-methyl-7-anilinofluoran, 3-dibutylamino-6-methyl-7-(2.4-dimethylanilino)fluoran, 3-dibutytamino-6-methyl-7-(2-chloroanilino)fluoran, 3-dibutylamino-6-methyl-7-(4-chloroanilino)fluoran, 3-dibutylamino-6-methyl-7-(2-fluoroanitino)fluoran, 3-dibutylamino-6-methyl-7-(3-trifluoromethylanilino) fluoran, 3-dibutylamino-6-ethoxyethyl-7-anilinofluoran, 3-dibutylamino-6-chloro-anilino fluoran, 3-dibutylamino-6-methyl-7-(4-methylanilino)fluoran, 3-dibutylamino-7-(2-chloroanilino)fluoran, 3-dibutylamino-7-(2-fluoroanilino)fluoran, 3-dibutylamino-7-(N-methyl-N-formylamino)fluoran, 3-dipentylamino-6-methyl-7-anilinofluoran, 3-dipentylamino-6-methyl-7-(4-2-chloroanilino)fluoran, 3-dipentylamino-7-(3-trifluoro methylanilino)fluoran, 3-dipentylamino-6-chloro-7-anilinofluoran, 3-dipentylamino-7-(4-chloroanilino)fluoran, 3-pyrrolidino-6-methyl-7-anilinofluoran, 3-piperidino-6-methyl-7-anilinofluoran, 3-(N-methyl-N-propylamino)-6-methyl-7-anilinoftuoran, 3-(N-methyl-N-cyclohexylamino)-6-methyl-7-anilinofluoran, 3-(N-ethyl-N-cyclohexylamino)-6-methyl-7-anilinofluoran, 3-(N-ethyl-p-toluidino)-6-methyl-7-anilinofluoran, 3-(N-ethyl-N-isoamylamino)-6-methyl-7-anilinofluoran, 3-(N-ethyl-N-isoamylamino)-6-chloro-7-anilinofluoran, 3-(N-ethyl-N-tetrahydrofurfurylamino)-6-methyl-7-anilinofluoran, 3-(N-ethyl-N-isobutylamino)-6-methyl-7-anilinofluoran, 3-(N-butyl-N-isoamylamino)-6-methyl-7-anilinofluoran, 3-(N-isopropyl-N-3-pentylamino)-6-methyl-7-anilinofluoran, 3-(N-ethyl-N-ethoxypropylamino)-6-methyl-7-anilinofluoran, 3-cyclohexylamino-6-chlorofluoran, 2-methyl-6-p-(p-dimethytaminophenyl)aminoanilinofluoran, 2-methoxy-6-p-(p-dimethyl aminophenyl)aminoanilinofluoran, 2-chloro-3-methyl-6-p-(p-phenylaminophenyl) aminoanilinofluoran, 2-diethylamino-6-p-(p-dimethylaminophenyl)aminoanilinofluoran, 2-phenyl-6-methyl-6-p-(p-phenylaminophenyl)aminoanilinofluoran, 2-benzyl-6-p-(p-phenylaminophenyl) aminoanilinofluoran, 3-methyl-6-p-(p-dimethylaminophenyl)amino-anilinofluoran, 3-diethylamino-6-p-(p-diethylaminophenyl)aminoanilinofluoran, 3-diethyl-amino-6-p-(p-dibutylaminophenyl)aminoanilinofluoran, 2.4-dimethyl-6-[(4-dimethylamino)-anilino]fluoran, 3-[(4-dimethylaminophenyl)amino]-5.7-dimethylfluoran, 3.6.6′-tris(dimethyl-amino)spiro[fluorene-9.3′-phthalide], 3.6.6′-tris(diethylamino)spiro [fluorene-9.3′-phthalide], 3.3-bis(p-dimethylaminophenyl)-6-dimethylaminophthalide, 3.3-bis(p-dimethylamino-phenyl)phthalide, 3.3-bis-[2-(p-dimethylaminophenyl)-2-(p-methoxyphenyl)ethenyl-4.5.6.7-tetrabromophthalide, 3.3-bis-[2-(p-dimethylaminophenyl)-2-(p-methoxyphenyl)ethenyl-4.5.6.7-tetrachlorophthalide, 3.3-bis[1.1-bis(4-pyrrolidinophenyl)ethylene-2-yl]-4.5.6.7-tetrabromophthalide, 3.3-bis-(1-(4-methoxyphenyl)-1-(4-pyrridinophenyl)ethylene-2-yl]-4.5.6.7-tetrachlorophthalide, 3-(4-diethylamino-2-ethoxyphenyl)-3-(1-ethyl-2-methylindole-3-yl)-4-azaphthalide, 3-(4-diethylamino-2-ethoxyphenyl)-3-(1-octyl-2-methylindole-3-yl)-4-azaphthalide, 3-(4-cyclohexylethylamino-2-methoxyphenyl)-3-(1-ethyl-2-methylindole-3-yl)-4-azaphthalide, 3.3-bis(1-ethyl-2-methylindole-3-yl)phthalide, 3.3-bis(1-octyl-2-methylindole-3-yl)phthalide, mixture of 2-phenyl-4-(4-diethylaminophenyl)-4-(4-methoxyphenyl)-6-methyl-7-dimethylamino-3.1-benzoxazine and 2-phenyl-4-(4-diethylaminophenyl)-4-(4-methoxyphenyl)-8-methyl-7-dimethylamino-3.1-benzoxazine, 4.4′-[1-methylethylidene)-bis(4.1-phenyleneoxy-4.2-quinazolinediyl)]bis[N,N-diethylbenzenamine], bis(N-methyldiphenylamine)-4-yl-(N-butylcarbazole)-3-yl-methane and combinations thereof.

In yet other aspects of the method, the color formers can be 3-diethylamino-6-methyl-7-anilinofluoran, 3-diethylamino-6-methyl-7-(3-methylanilino)fluoran, 3-diethylamino-6-methyl-7-(2.4-dimethylanilino)fluoran, 3-dibutylamino-6-methyl-7-anilino fluoran, 3-dipentylamino-6-methyl-7-anilinofluoran, 3-(N-methyl-N-propylamino)-6-methyl-7-anilinofluoran, 3-(N-methyl-N-cyclohexylamino)-6-methyl-7-anilinofluoran, 3-(N-ethyl-N-isoamylamino)-6-methyl-7-anilinofluoran, 3-diethylamino-6-chloro-7-anilino fluoran, 3-dibutylamino-7-(2-chloroanilino)fluoran, 3-N-ethyl-p-toluidino-6-methyl-7-anilinofluoran, 3-(N-ethyl-N-tetrahydrofurfurylamino)-6-methyl-7-anilinofluoran, 3-(N-ethyl-N-isobutylamino)-6-methyl-7-anilinofluoran, 3-N-ethyl-N-ethoxypropylamino-6-methyl-7-anilinofluoran, 2.4-dimethyl-6-[(4-dimethylamino)anilinolfluoran, 3-(4-diethylamino-2-ethoxyphenyl)-3-(1-octyl-2-methylindole-3yl)-4-azaphthalide, 3.3-bis(p-dimethylamino-phenyl)-6-dimethytaminophthalide and combinations thereof.

All of the above color formers can be used singly or as a mixture with other color formers; or they may also be used together with further black color formers or color forming compounds. It is also possible to use solid solutions comprising at least two color formers or color forming compounds.

In yet other aspects of the method, the recording composition can include image stabilizers, other sensitizers, fillers, binders, dispersants, antioxidants, anti-tack agents, antifoaming agents, desensitizers, light stabilizers, fluorescent brightening agents and combinations thereof.

These additional agents may be contained in the heat-sensitive layer or may be contained in any layer, for example, a protective or topcoat layer, when the method consists of a multilayer structure. For example, when a topcoat layer or an undercoat layer is provided in the upper and/or lower parts of the heat-sensitive layer, these layers can contain antioxidants, light stabilizers, etc. Furthermore, these antioxidants or light stabilizers can be contained in a form encapsulated in microcapsules, as needed, in these layers.

In some aspects of the method, the heat-sensitive recording material can be used in a thermal printing process or laser marking/printing process, such as a CO₂, Nd:YAG or FLDA-LED process.

Also provided for is a recording sheet that includes a substrate, a recording composition deposited onto or applied to the substrate, the recording composition comprises one or more color formers, one or more color developers, and at least one sensitizer comprising a mixture of ortho-toluenesulfonamide and para-toluenesulfonamides (OPTSA).

In some aspects of the recording sheet, the at least one sensitizer of the recording composition has a ratio of ortho-toluenesulfonamides to para-toluenesulfonamides of from about 0.5:99.5 to about 99.5:0.5, can be from about 5:90 to about 90:5, can be 10:85 to about 85:10, can be from about 20:80 to about 80:20, and maybe from about 40:60 to about 60:40, based on dry weight of the OPTSA mixture.

In other aspects of the recording sheet, the at least one sensitizer of the recording composition is present in an amount of from about 0.1 to about 6 parts by dry mass per one part of the one or more color formers, can be in an amount of 0.5 to 5.0 parts by dry mass, and may be in an amount of 1.0 to 4.0 parts by dry mass of the recording composition.

In some aspects of the recording sheet, the one or more color developers of the recording composition can be a phenolic color developer, non-phenolic color developer or combinations thereof. For example, the one or more of the color developers of the recording composition can be 5-(N-3-methylphenyl-sulfonylamido)-(N′,N″-bis-(3-methylphenyl)-isophthalic acid diamide and [3-(p-tolylsulfonylcarbamoylamino)phenyl]4-methylbenzenesulfonate, 2.4′-dihydroxydiphenylsulfone, 4.4′-dihydroxydiphenylsulfone, bis-(3-allyl-4-hydroxyphenyl)sulfone, 4-[4′-[(1′-methylethyloxy)phenyl]sulfonyl]phenol, 4-hydroxyphenyl 4-isoprooxyphenylsulfone, N-{2-[(phenylcarbamoyl)amino]phenyl} benzenesulfonamide, phenol, 4-[[4-(2-propenlyloxy)phenyl]sulfonyl, 4-hydroxy-4′benzyloxydiphenylsulfone, and 4.4′bis(N-carbamoyl-4-methylbenzenesulfonamide) diphenylmethane, 4.4′-sulfonylbis-polymer with 1.1′-oxybis[2-chloroethane], phenols, urea urethane compounds and combinations thereof.

In yet other aspects of the recording sheet, the one or more color formers of the recording composition can be fluoran, phthalide, lactam, triphenylmethane, phenothiazine, spiropyran leuco dyes and combinations thereof. For example, the one more color formers can be 2-anilino-3-methyl-6-diethylaminofluorane, 2-anilino-3-methyl-6-dibutylamino fluorane, 2-anilino-3-methyl-6-(methyl-N-isoamylamino)fluorine, 2-anilino-3-methyl-6-(N-ethyl-N-propylamino)fluorane, 2-anilino-3-methyl-6-di-n-amylaminofluorane, 2-anilino-3-methyl-6-(N-ethyl-N-ptolylamino)fluorane, 2-anilino-3-methyl-6-N-ethyl-N-sec-butylamino fluorane, 3-di-(n-pentylamino)-6-methyl-7-anilinofluorane, 3-(N-isoamyl-N-ethylamino)-6-methyl-7-anilinofluorane, 3-(N-n-hexyl-N-ethylamino)-6-methyl-7-anilinofluorane, 3-[N-(3-ethoxypropyl)-N-ethylamino]-6-methyl-7-anilinofluorane, 3-di-(n-butylamino)-7-2-chloroanilino)fluorane, 3-diethylamino-7-(2-chloroanilino)fluorane, and 3-(N-cyclohexyl-N-methylamino)-6-methyl-7-anilinofluorane, 6-methyl-7-anilinofluorane and combinations thereof.

In still other aspects of the recording sheet, the recording composition can further include image stabilizers, sensitizers, fillers, binders, dispersants, antioxidants, anti-tack agents, antifoaming agents, light stabilizers, fluorescent brightening agents and combinations thereof.

In other aspects of the recording sheet, one or more undercoats is applied between the substrate and the heat or thermosensitive (used interchangeably herein) layer to improve the resolution of the image by enhancing the smoothness of the surface of substrate and to improve the image sensitivity by enhancing heat insulation. The undercoat or layer comprises inorganic filler like calcined kaolin or/and organic fillers like hollow spheres, and binder agent as main components. A topcoat layer(s) with a barrier effect can be deposited onto or applied on the recording sheet, to prevent infiltration, migration, diffusion of external agents which can cause printed image or and the background deteriorations, this layer can be composed for example by a water-resistance-imparting agent, a pigment, an auxiliary agent, a binder, and one or more various auxiliary agents without using any pigment, or using a binder and a pigment together. The protective layer coating composition may further comprise various auxiliary agents as necessary, such as wax, silicone derivatives, etc. . . . . The undercoat layer is deposited directly onto the support or substrate, followed by the heat-sensitive composition layer(s), followed by the topcoat or protective layer. The heat-sensitive recording material according to the first embodiment of the present invention may comprise a back layer mainly comprising a pigment and a binder and formed on the support at the side opposite to the side of the heat-sensitive recording layer as necessary. This can enhance preservability, curling suitability, and printing performance. Further, various techniques known in the field of manufacturing heat-sensitive recording materials may be applied as required. For example, the rear surface of the heat-sensitive recording material may be treated with an adhesive to form an adhesive label, or may be provided with a magnetic recording layer, a coating layer for printing, a thermal transfer recording layer, an ink jet recording layer, or the like.

In still other aspects of the recording sheet, the recording sheet can be used in a thermal printing process or laser marking/printing process, such as a CO₂, Nd:YAG or FLDA-LED process.

### EXAMPLES

### I. Preparation of Color Developer Dispersion A (Solution A)

A mixture of 13.6 g of 5-(N-3-methylphenyl-sulfonylamido)-(N′,N″-bis-(3-methylphenyl)-isophthalic acid diamide (Pergafast™ 425 from Solenis), 0.3 g of the surfactant 2.4.7.9-tetramethyl-5-decyne-4.7-diol (Surfynol® 104 from Evonik) as 20% solution in isopropanol, 13.6 g of a aqueous solution (as 10%) of Gohsenx™ L-3266 (sulfonated polyvinyl alcohol, Nippon Gohsei) as dispersing aid and binder and 22.5 g demineralized water was milled in a bead mill to a median particle size diameter of 1.0 μm to obtain color developer dispersion A.

### II. Preparation of Color Developer Dispersion B (Solution B)

A mixture of 13.6 g of [3-(p-tolylsulfonylcarbamoylamino)phenyl]4-methylbenzenesulfonate (Pergafast™ 201 from Solenis), 0.3 g of the surfactant 2.4.7.9-tetramethyl-5-decyne-4.7-diol (Surfynol® 104 from Evonik) as 20% solution in isopropanol, 13.6 g of a aqueous solution (as 10%) of Poval™ 6-77 KL (modified polyvinyl alcohol, Kuraray) as dispersing aid and binder and 22.5 g demineralized water was milled in a bead mill to a median particle size diameter of 1.0 μm to obtain color developer dispersion B.

### III. Preparation of Color Former Dispersion C (Solution C)

A mixture of 16.6 g of 3-di-n-butylamino-6-methyl-7-phenylaminofluoran (WinCon-2, Connect Chemicals), 22.2 g of a 15% by weight solution of a partially hydrolyzed polyvinyl alcohol (Poval™ 3-88 from Kuraray), 0.3 g of the surfactant 2.4.7.9-tetramethyl-5-decyne-4.7-diol (Surfynol® 104 from Evonik) as 20% solution in isopropanol and 10.9 g of water was milled in a bead mill to an average particle diameter of 1.0 μm to obtain Dispersion C.

### IV. Preparation of Sensitizer Dispersion D (Solution D)

A mixture of 4.5 g of o-Toluenesulfonamide (Sigmaaldrich), 6.8 g of p-Toluenesulfonamide (Sigmaaldrich), 3.8 g of a 15% by weight solution of a partially hydrolyzed polyvinyl alcohol (Poval™ 3-88 from Kuraray), 5.7 g of a aqueous solution (as 10%) of Gohsenx™ L-3266 (sulfonated polyvinyl alcohol Nippon Gohsei) as dispersing aid and binder, 0.3 g of the surfactant 2.4.7.9-tetramethyl-5-decyne-4.7-diol (Surfynol® 104 from Evonik) as 20% solution in isopropanol and 29.0 g of water was milled in a bead mill to an average particle diameter of 1.0 μm to obtain Dispersion D.

### V. Preparation of Sensitizer Dispersion E (Solution E)

A mixture of 11.3 g of p-Toluenesulfonamide (Sigmaaldrich), 3.8 g of a 15% by weight solution of a partially hydrolyzed polyvinyl alcohol (Poval™ 3-88 from Kuraray), 5.7 g of a aqueous solution (as 10%) of Gohsenx™ L-3266 (sulfonated polyvinyl alcohol Nippon Gohsei) as dispersing aid and binder, 0.3 g of the surfactant 2.4.7.9-tetramethyl-5-decyne-4.7-diol (Surfynol® 104 from Evonik) as 20% solution in isopropanol and 29.0 g of water was milled in a bead mill to an average particle diameter of 1.0 μm to obtain Dispersion E.

### VI. Preparation of Sensitizer Dispersion F (Solution F)

A mixture of 11.3 g of o-Toluenesulfonamide (Sigmaaldrich), 3.8 g of a 15% by weight solution of a partially hydrolyzed polyvinyl alcohol (Poval™ 3-88 from Kuraray), 5.7 g of a aqueous solution (as 10%) of Gohsenx™ L-3266 (sulfonated polyvinyl alcohol Nippon Gohsei) as dispersing aid and binder, 0.3 g of the surfactant 2.4.7.9-tetramethyl-5-decyne-4.7-diol (Surfynol® 104 from Evonik) as 20% solution in isopropanol and 29.0 g of water was milled in a bead mill to an average particle diameter of 1.0 μm to obtain Dispersion F.

### VII. Preparation of Sensitizer Dispersion G (Solution G)

A mixture of 11.3 g of 1.2-diphenoxyethane (DPE, from Connect Chemicals), 3.8 g of a 15% by weight solution of a partially hydrolyzed polyvinyl alcohol (Poval™ 3-88 from Kuraray), 5.7 g of a aqueous solution (as 10%) of Gohsenx™ L-3266 (sulfonated polyvinyl alcohol Nippon Gohsei) as dispersing aid and binder, 0.3 g of the surfactant 2.4.7.9-tetramethyl-5-decyne-4.7-diol (Surfynol® 104 from Evonik) as 20% solution in isopropanol and 29.0 g of water was milled in a bead mill to an average particle diameter of 1.0 μm to obtain Dispersion G.

### VIII. Preparation of Sensitizer Dispersion H (Solution H)

A mixture of 11.3 g of 1.2-bis-(3-methyl-phenoxy)ethane (from Connect Chemicals), 3.8 g of a 15% by weight solution of a partially hydrolyzed polyvinyl alcohol (Poval™ 3-88 from Kuraray), 5.7 g of a aqueous solution (as 10%) of Gohsenx™ L-3266 (sulfonated polyvinyl alcohol Nippon Gohsei) as dispersing aid and binder, 0.3 g of the surfactant 2.4.7.9-tetramethyl-5-decyne-4.7-diol (Surfynol® 104 from Evonik) as 20% solution in isopropanol and 29.0 g of water was milled in a bead mill to an average particle diameter of 1.0 μm to obtain Dispersion H.

### XI. Preparation of Sensitizer Dispersion I (Solution I)

A mixture of 11.3 g of diphenyl sulfone (from Sigmaaldrich), 3.8 g of a 15% by weight solution of a partially hydrolyzed polyvinyl alcohol (Poval™ 3-88 from Kuraray), 5.7 g of a aqueous solution (as 10%) of Gohsenx™ L-3266 (sulfonated polyvinyl alcohol Nippon Gohsei) as dispersing aid and binder, 0.3 g of the surfactant 2.4.7.9-tetramethyl-5-decyne-4.7-diol (Surfynol® 104 from Evonik) as 20% solution in isopropanol and 29.0 g of water was milled in a bead mill to an average particle diameter of 1.0 μm to obtain Dispersion I.

### X. Preparation of Sensitizer Dispersion J (Solution J)

A mixture of 11.3 g of benzyl-2-naphthyl ether (Pergaspeed™305, BASF SE), 3.8 g of a 15% by weight solution of a partially hydrolyzed polyvinyl alcohol (Poval™ 3-88 from Kuraray), 5.7 g of a aqueous solution (as 10%) of Gohsenx™ L-3266 (sulfonated polyvinyl alcohol Nippon Gohsei) as dispersing aid and binder, 0.3 g of the surfactant 2.4.7.9-tetramethyl-5-decyne-4.7-diol (Surfynol® 104 from Evonik) as 20% solution in isopropanol and 29.0 g of water was milled in a bead mill to an average particle diameter of 1.0 μm to obtain Dispersion J.

### XI. Preparation of Sensitizer Dispersion K (Solution K)

A mixture of 11.3 g of di-(p-methylbenzyl)oxalate (from DIC Corporation), 3.8 g of a 15% by weight solution of a partially hydrolyzed polyvinyl alcohol (Poval™ 3-88 from Kuraray), 5.7 g of a aqueous solution (as 10%) of Gohsenx™ L-3266 (sulfonated polyvinyl alcohol Nippon Gohsei) as dispersing aid and binder, 0.3 g of the surfactant 2.4.7.9-tetramethyl-5-decyne-4.7-diol (Surfynol® 104 from Evonik) as 20% solution in isopropanol and 29.0 g of water was milled in a bead mill to an average particle diameter of 1.0 μm to obtain Dispersion K.

### XII. Preparation of Sensitizer Dispersion L (Solution L)

A mixture of 11.3 g of dimethylterephthalate (DMT) (from Connect Chemicals), 3.8 g of a 15% by weight solution of a partially hydrolyzed polyvinyl alcohol (Poval™ 3-88 from Kuraray), 5.7 g of a aqueous solution (as 10%) of Gohsenx™ L-3266 (sulfonated polyvinyl alcohol Nippon Gohsei) as dispersing aid and binder, 0.3 g of the surfactant 2.4.7.9-tetramethyl-5-decyne-4.7-diol (Surfynol® 104 from Evonik) as 20% solution in isopropanol and 29.0 g of water was milled in a bead mill to an average particle diameter of 1.0 μm to obtain Dispersion L.

### XIII. Preparation of Sensitizer Dispersion M (Solution M)

A mixture of 11.3 g of dimethylterephthalate (DMT) (from Connect Chemicals), 3.8 g of a 15% by weight solution of a partially hydrolyzed polyvinyl alcohol (Poval™ 3-88 from Kuraray), 5.7 g of a aqueous solution (as 10%) of Gohsenx™ L-3266 (sulfonated polyvinyl alcohol Nippon Gohsei) as dispersing aid and binder, 0.3 g of the surfactant 2.4.7.9-tetramethyl-5-decyne-4.7-diol (Surfynol® 104 from Evonik) as 20% solution in isopropanol and 29.0 g of water was milled in a bead mill to an average particle diameter of 1.0 μm to obtain Dispersion M.

### XIV. Preparation of Filler Dispersion N (Solution N)

A mixture of 19.8 g calcined kaolin (Ansilex® 93 from BASF SE), 0.5 g of an aqueous solution of a dispersing agent (sodium polyacrylate (DISPEX® AA 4140 from BASF SE), pH 7.5, active content 40% by weight), and 29.7 g of water was milled in a bead mill to an average particle diameter of 1.0 μm to obtain Dispersion N.

### XV. Preparation of Filler Dispersion O (Solution O)

A mixture of 9.1 g of silica medium particle size and moderate oil absorption capacity (Sipernat®120 from Evonik), 0.2 g of the surfactant 2.4.7.9-tetramethyl-5-decyne-4.7-diol (Surfynol® 104 from Evonik) as 20% solution in isopropanol, 9.1 g of an aqueous solution (as 10%) of Gohsenx™ L-3266 (sulfonated polyvinyl alcohol, Nippon Gohsei) as dispersing aid and binder and 31.7 g demineralized water was milled in a bead mill to a median particle size diameter of 1.0 μm to obtain Dispersion O.

### Example 1—Thermosensitive Coloring Liquids & Coating Preparations (See Table 1)

### Sample A0:

Preparation of a heat-sensitive recording layer coating composition with 125 parts of solution A, 50 parts of solution C, 15 parts of a stearic acid amide dispersion (Hymicron L-271, from Chuko Yushi Co., LTD) with 25% non-volatile content, 40 parts of a 17% dry content zinc stearate dispersion (Hidorin F115, from Chuko Europe), 200 parts of a 10% by weight aqueous solution of a polyvinyl alcohol (Poval® 28-99, polyvinyl alcohol, Kuraray Europe GmbH), 150 parts of solution N, and 580 parts of distilled water were mixed and stirred to obtain a heat-sensitive recording layer coating composition.

A base paper, pre-coated with calcined kaolin (Ansilex® 93 from BASF SE based, coating weight 7 g/m2) was coated with the above heat-sensitive recording layer coating composition using an adapted wire bar (#3—K bars, from RK Printcoat instruments Ltd.) to reach a dry color former coating weight of 0.35 g/m² and dried with hot air blower. This coated thermosensitive sheet was stored at 40° C. for 24 hours. The resulting heat-sensitive recording layer coating composition was calendered with 25 kN with 2 passes, to obtain a smooth surface.

### Sample A1:

Preparation of a heat-sensitive recording layer coating composition with 125 parts of solution A, 50 parts of solution C, 75 parts of solution D, 15 parts of a stearic acid amide dispersion (Hymicron L-271, from Chuko Yushi Co., LTD) with 25% non-volatile content, 40 parts of a 17% dry content zinc stearate dispersion (Hidorin F115, from Chuko Europe), 200 parts of a 10% by weight aqueous solution of a polyvinyl alcohol (Poval® 28-99, polyvinyl alcohol, Kuraray Europe GmbH), 150 parts of solution N, and 510 parts of distilled water were mixed and stirred to obtain a heat-sensitive recording layer coating composition.

A base paper, pre-coated with calcined kaolin (Ansilex® 93 from BASF SE based, coating weight 7 g/m2) was coated with the above heat-sensitive recording layer coating composition using an adapted wire bar (#3—K bars, from RK Printcoat instruments Ltd.) to reach a dry color former coating weight of 0.35 g/m² and dried with hot air blower. This coated thermosensitive sheet was stored at 40° C. for 24 hours. The resulting heat-sensitive recording layer coating composition was calendered with 25 kN with 2 passes, to obtain a smooth surface.

### Sample A2:

Preparation of a heat-sensitive recording layer coating composition with 125 parts of solution A, 50 parts of solution C, 150 parts of solution D, 15 parts of a stearic acid amide dispersion (Hymicron L-271, from Chuko Yushi Co., LTD) with 25% non-volatile content, 40 parts of a 17% dry content zinc stearate dispersion (Hidorin F115, from Chuko Europe), 200 parts of a 10% by weight aqueous solution of a polyvinyl alcohol (Poval® 28-99, polyvinyl alcohol, Kuraray Europe GmbH), 150 parts of solution N, and 430 parts of distilled water were mixed and stirred to obtain a heat-sensitive recording layer coating composition.

A base paper, pre-coated with calcined kaolin (Ansilex® 93 from BASF SE based, coating weight 7 g/m2) was coated with the above heat-sensitive recording layer coating composition using an adapted wire bar (#3—K bars, from RK Printcoat instruments Ltd.) to reach a dry color former coating weight of 0.35 g/m² and dried with hot air blower. This coated thermosensitive sheet was stored at 40° C. for 24 hours. The resulting heat-sensitive recording layer coating composition was calendered with 25 kN with 2 passes, in order to obtain a smooth surface.

### Sample A3:

A heat-sensitive recording material was produced in the same manner as in Sample A2 except that, in the preparation of the heat-sensitive recording layer, 225 parts of solution D were used instead of 150 parts and 360 parts of distilled water instead of 430 parts.

### Sample A4:

A heat-sensitive recording material was produced in the same manner as in Sample A3 except that, in the preparation of the heat-sensitive recording layer, 300 parts of solution D were used instead of 225 parts and 280 parts of distilled water instead of 360 parts.

### Sample A5, and A6:

A heat-sensitive recording material was produced in the same manner as in Sample A2 except that, in the preparation of the heat-sensitive recording layer, solution E for the sample A5 and solution F for the sample A6 were used instead of the solution D.

### Sample A1-1:

A heat-sensitive recording material was produced in the same manner as in Sample A1 except that, in the preparation of the heat-sensitive recording layer, 75 parts of solution G were added in addition, and 430 parts of distilled water were used instead of 510 parts.

### Sample B1-1, and C1-1:

A heat-sensitive recording material was produced in the same manner as in Sample A1-1 except that, in the preparation of the heat-sensitive recording layer, solution H for the Sample B1-1 and solution I for the Sample C1-1 were used instead of the solution G.

### Sample A1-2:

A heat-sensitive recording material was produced in the same manner as in Sample A1-1 except that, in the preparation of the heat-sensitive recording layer, 150 parts of solution G were added instead of 75 parts, and 360 parts of distilled water were used instead of 430 parts.

### Sample B1-2, and C1-2:

A heat-sensitive recording material was produced in the same manner as in Sample A1-2 except that, in the preparation of the heat-sensitive recording layer, solution H for the Sample B1-2 and solution I for the Sample C1-2 were used instead of the solution G.

### Sample A2-1:

A heat-sensitive recording material was produced in the same manner as in Sample A1-2 except that, in the preparation of the heat-sensitive recording layer, 75 parts of solution G were added instead of 150 parts, 150 parts of solution D were added instead of 75 parts.

### Samples B2-1, C2-1, D2-1, E2-1 and F2-1:

A heat-sensitive recording material was produced in the same manner as in Sample A2-1 except that, in the preparation of the heat-sensitive recording layer, solution H for the Sample B2-1, solution I for the Sample C2-1, solution J for the Sample D2-1, solution K for the Sample E2-1 and solution L for the Sample F2-1 were used instead of the solution G.

### Sample G1-1:

A heat-sensitive recording material was produced in the same manner as in Sample A1 except that, in the preparation of the heat-sensitive recording layer, 90 parts of a stearic acid amide dispersion (Hymicron L-271, from Chuko Yushi Co., LTD) with 25% non-volatile content were added instead of 15 parts, and 430 parts of distilled water were used instead of 510 parts.

### Sample G1-2:

A heat-sensitive recording material was produced in the same manner as in Sample G1-1 except that, in the preparation of the heat-sensitive recording layer, 165 parts of a stearic acid amide dispersion (Hymicron L-271, from Chuko Yushi Co., LTD) with 25% non-volatile content were added instead of 90 parts, and 280 parts of distilled water were used instead of 430 parts.

### Sample G2-1:

A heat-sensitive recording material was produced in the same manner as in Sample A2 except that, in the preparation of the heat-sensitive recording layer, 90 parts of a stearic acid amide dispersion (Hymicron L-271, from Chuko Yushi Co., LTD) with 25% non-volatile content were added instead of 15 parts, and 360 parts of distilled water were used instead of 430 parts.

### Sample H-1:

A heat-sensitive recording material was produced in the same manner as in Sample A1 except that, in the preparation of the heat-sensitive recording layer, 37.5 parts of solution G were added in addition, 52.5 parts of a stearic acid amide dispersion (Hymicron L-271, from Chuko Yushi Co., LTD) with 25% non-volatile content were added instead of 15 parts, and 430 parts of distilled water were used instead of 510 parts.

TABLE 1

| | Thermal solution (parts by mass) | | | | | | | | | | | |
|---|---|---|---|---|---|---|---|---|---|---|---|---|
| | A0 | A1 | A2 | A3 | A4 | A5 | A6 | A1-1 | A1-2 | A2-1 | B1-1 | B1-2 |
| Solution A | 125 | 125 | 125 | 125 | 125 | 125 | 125 | 125 | 125 | 125 | 125 | 125 |
| Solution C | 50 | 50 | 50 | 50 | 50 | 50 | 50 | 50 | 50 | 50 | 50 | 50 |
| Solution D | | 75 | 150 | 225 | 300 | | | 75 | 75 | 150 | 75 | 75 |
| Solution E | | | | | | 150 | | | | | | |
| Solution F | | | | | | | 150 | | | | | |
| Solution G | | | | | | | | 75 | 150 | 75 | | |
| Solution H | | | | | | | | | | | 75 | 150 |
| Solution I | | | | | | | | | | | | |
| Solution J | | | | | | | | | | | | |
| Solution K | | | | | | | | | | | | |
| Solution L | | | | | | | | | | | | |
| Hymicron L-271 | 15 | 15 | 15 | 15 | 15 | 15 | 15 | 15 | 15 | 15 | 15 | 15 |
| Hidorin F-115 | 40 | 40 | 40 | 40 | 40 | 40 | 40 | 40 | 40 | 40 | 40 | 40 |
| Mowio 28-99 sol. 10% | 200 | 200 | 200 | 200 | 200 | 200 | 200 | 200 | 200 | 200 | 200 | 200 |
| Solution N | 150 | 150 | 150 | 150 | 150 | 150 | 150 | 150 | 150 | 150 | 150 | 150 |

| | Thermal solution (parts by mass) | | | | | | | | | | |
|---|---|---|---|---|---|---|---|---|---|---|---|
| | B2-1 | C1-1 | C1-2 | C2-1 | D2-1 | E2-1 | F2-1 | G1-1 | G1-2 | G2-1 | H1 |
| Solution A | 125 | 125 | 125 | 125 | 125 | 125 | 125 | 125 | 125 | 125 | 125 |
| Solution C | 50 | 50 | 50 | 50 | 50 | 50 | 50 | 50 | 50 | 50 | 50 |
| Solution D | 150 | 75 | 75 | 150 | 150 | 150 | 150 | 75 | 75 | 150 | 75 |
| Solution E | | | | | | | | | | | |
| Solution F | | | | | | | | | | | |
| Solution G | | | | | | | | | | | 37.5 |
| Solution H | 75 | | | | | | | | | | |
| Solution I | | 75 | 150 | 75 | | | | | | | |
| Solution J | | | | | 75 | | | | | | |
| Solution K | | | | | | 75 | | | | | |
| Solution L | | | | | | | 75 | | | | |
| Hymicron L-271 | 15 | 15 | 15 | 15 | 15 | 15 | 15 | 90 | 165 | 90 | 52,5 |
| Hidorin F-115 | 40 | 40 | 40 | 40 | 40 | 40 | 40 | 40 | 40 | 40 | 40 |
| Mowio 28-99 sol. 10% | 200 | 200 | 200 | 200 | 200 | 200 | 200 | 200 | 200 | 200 | 200 |
| Solution N | 150 | 150 | 150 | 150 | 150 | 150 | 150 | 150 | 150 | 150 | 150 |

### Example 2—Heat-Sensitive Coloring Liquids & Coating Preparations (See Table 2)

### Sample R1:

Preparation of a heat-sensitive recording layer coating composition with 125 parts of solution B, 50 parts of solution C, 15 parts of a stearic acid amide dispersion (Hymicron L-271, from Chuko Yushi Co., LTD) with 25% non-volatile content, 40 parts of a 17% dry content zinc stearate dispersion (Hidorin F115, from Chuko Europe), 200 parts of a 10% by weight aqueous solution of a polyvinyl alcohol (Poval® 28-99, polyvinyl alcohol, Kuraray Europe GmbH), 150 parts of solution N, and 580 parts of distilled water were mixed and stirred to obtain a heat-sensitive recording layer coating composition.

A base paper, pre-coated with calcined kaolin (Ansilex® 93 from BASF SE based, coating weight 7 g/m2) was coated with the above heat-sensitive recording layer coating composition using an adapted wire bar (#3—K bars, from RK Printcoat instruments Ltd.) to reach a dry color former coating weight of 0.35 g/m² and dried with hot air blower. This coated thermosensitive sheet was stored at 40° C. for 24 hours. The resulting heat-sensitive recording layer coating composition was calendered with 25 kN with 2 passes, to obtain a smooth surface.

### Sample R2:

Preparation of a heat-sensitive recording layer coating composition with 125 parts of solution B, 50 parts of solution C, 150 parts of solution D, 15 parts of a stearic acid amide dispersion (Hymicron L-271, from Chuko Yushi Co., LTD) with 25% non-volatile content, 40 parts of a 17% dry content zinc stearate dispersion (Hidorin F115, from Chuko Europe), 200 parts of a 10% by weight aqueous solution of a polyvinyl alcohol (Poval® 28-99, polyvinyl alcohol, Kuraray Europe GmbH), 150 parts of solution N, and 430 parts of distilled water were mixed and stirred to obtain a heat-sensitive recording layer coating composition.

A base paper, pre-coated with calcined kaolin (Ansilex® 93 from BASF SE based, coating weight 7 g/m2) was coated with the above heat-sensitive recording layer coating composition using an adapted wire bar (#3—K bars, from RK Printcoat instruments Ltd.) to reach a dry color former coating weight of 0.35 g/m² and dried with hot air blower. This coated thermosensitive sheet was stored at 40° C. for 24 hours. The resulting heat-sensitive recording layer coating composition was calendered with 25 kN with 2 passes, to obtain a smooth surface.

### Sample R3:

A heat-sensitive recording material was produced in the same manner as in Sample R1 except that, in the preparation of the heat-sensitive recording layer, solution A was used instead of the solution B.

### Sample R4:

A heat-sensitive recording material was produced in the same manner as in Sample R2 except that, in the preparation of the heat-sensitive recording layer, solution A was used instead of the solution B.

### Sample R5:

A heat-sensitive recording material was produced in the same manner as in Sample R4 except that, in the preparation of the heat-sensitive recording layer, 250 parts of solution O were used instead of the solution N, and 335 parts of distilled water were used instead of 430 parts.

TABLE 2

| | Thermal solution (parts by mass) | | | | |
|---|---|---|---|---|---|
| | R1 | R2 | R3 | R4 | R5 |
| Solution A | | | 125 | 125 | 125 |
| Solution B | 125 | 125 | | | |
| Solution C (color former) | 50 | 50 | 50 | 50 | 50 |
| Solution D | | 150 | | 150 | 150 |
| Solution N | 150 | 150 | 150 | 150 | |
| Solution O | | | | | 250 |
| Hymicron L-271 | 15 | 15 | 15 | 15 | 15 |
| Hidorin F-115 | 40 | 40 | 40 | 40 | 40 |
| Mowio 28-99 sol. 10% | 200 | 200 | 200 | 200 | 200 |

### Evaluation of Heat-Sensitive Recording Compositions and Materials (Tables 3 and 4)

### Dynamic Sensitivity:

The heat-sensitive recording materials prepared according to embodiments herein were evaluated as described below and the results of the evaluations are summarized in Table 3.

The evaluation consisted of printing a thermal image pattern with a gradual energy conditions per surface unit, and in dynamic conditions, at a certain printing speed

In the current study, a ZEBRA™ ZT610 direct thermal printer with a 201 dpi flat thermal printing head (manufactured by ZEBRA Technologies Corp.) was used. Each heat-sensitive recording material was printed at a speed of 200 mm/s with a gradual printing energy per pattern as follow: 2-4-6-9-12-15-18-21-24-27-30.

The obtained printed patterns were evaluated by measuring the optical density (black filter), [O.D], with an X-Rite/Densieye™ 700 (from X-Rite Europe GmbH) optical densitometer. Higher O.D., with a fixed energy & speed conditions, means higher dynamic image sensitivity.

TABLE 3
Results of Example 1

| | Printer Energy | | | | | | | | | | | |
|---|---|---|---|---|---|---|---|---|---|---|---|---|
| | 0 | 2 | 4 | 6 | 9 | 12 | 15 | 18 | 21 | 24 | 27 | 30 |
| A0 | 0.05 | 0.05 | 0.06 | 0.07 | 0.11 | 0.22 | 0.35 | 0.55 | 0.72 | 0.83 | 0.96 | 0.99 |
| A1 | 0.05 | 0.05 | 0.07 | 0.11 | 0.22 | 0.39 | 0.58 | 0.78 | 0.89 | 1.00 | 1.05 | 1.08 |
| A2 | 0.05 | 0.07 | 0.10 | 0.18 | 0.39 | 0.60 | 0.83 | 1.00 | 1.08 | 1.13 | 1.18 | 1.18 |
| A3 | 0.05 | 0.07 | 0.12 | 0.21 | 0.42 | 0.69 | 0.90 | 1.07 | 1.11 | 1.14 | 1.18 | 1.18 |
| A4 | 0.05 | 0.08 | 0.12 | 0.23 | 0.44 | 0.71 | 0.92 | 1.08 | 1.12 | 1.15 | 1.17 | 1.17 |
| A5 | 0.05 | 0.08 | 0.11 | 0.17 | 0.34 | 0.52 | 0.72 | 0.93 | 1.02 | 1.07 | 1.10 | 1.11 |
| A6 | 0.05 | 0.08 | 0.11 | 1.15 | 0.30 | 0.49 | 0.68 | 0.89 | 0.99 | 1.04 | 1.06 | 1.05 |
| A1-1 | 0.05 | 0.08 | 0.11 | 0.19 | 0.36 | 0.57 | 0.80 | 0.97 | 1.06 | 1.12 | 1.16 | 1.15 |
| A1-2 | 0.05 | 0.09 | 0.14 | 0.23 | 0.44 | 0.68 | 0.88 | 1.01 | 1.08 | 1.10 | 1.13 | 1.14 |
| A2-1 | 0.05 | 0.09 | 0.14 | 0.26 | 0.50 | 0.75 | 0.95 | 1.06 | 1.10 | 1.13 | 1.15 | 1.15 |
| B1-1 | 0.05 | 0.08 | 0.11 | 0.19 | 0.35 | 0.56 | 0.80 | 0.98 | 1.05 | 1.11 | 1.15 | 1.15 |
| B1-2 | 0.05 | 0.09 | 0.14 | 0.22 | 0.43 | 0.65 | 0.86 | 1.00 | 1.08 | 1.09 | 1.13 | 1.13 |
| B2-1 | 0.05 | 0.09 | 0.14 | 0.25 | 0.49 | 0.75 | 0.96 | 1.07 | 1.11 | 1.13 | 1.16 | 1.14 |
| C1-1 | 0.05 | 0.07 | 0.09 | 0.16 | 0.32 | 0.51 | 0.70 | 0.85 | 0.95 | 1.02 | 1.06 | 1.09 |
| C1-2 | 0.05 | 0.07 | 0.12 | 0.19 | 0.39 | 0.60 | 0.77 | 0.93 | 1.00 | 1.05 | 1.08 | 1.09 |
| C2-1 | 0.05 | 0.07 | 0.10 | 0.17 | 0.37 | 0.60 | 0.78 | 0.96 | 1.05 | 1.11 | 1.13 | 1.16 |
| D2-1 | 0.06 | 0.08 | 0.15 | 0.27 | 0.52 | 0.77 | 0.98 | 1.08 | 1.13 | 1.15 | 1.16 | 1.15 |
| E2-1 | 0.05 | 0.07 | 0.10 | 0.17 | 0.36 | 0.58 | 0.75 | 0.95 | 1.04 | 1.11 | 1.13 | 1.14 |
| F2-1 | 0.05 | 0.09 | 0.12 | 0.22 | 0.46 | 0.72 | 0.91 | 1.02 | 1.04 | 1.08 | 1.09 | 1.06 |
| G1-1 | 0.06 | 0.07 | 0.11 | 0.18 | 0.37 | 0.58 | 0.81 | 0.94 | 1.03 | 1.09 | 1.14 | 1.15 |
| G1-2 | 0.06 | 0.07 | 0.11 | 0.21 | 0.41 | 0.61 | 0.79 | 0.94 | 1.05 | 1.09 | 1.11 | 1.12 |
| G2-1 | 0.05 | 0.07 | 0.11 | 0.17 | 0.35 | 0.62 | 0.84 | 1.01 | 1.11 | 1.16 | 1.16 | 1.15 |
| H1 | 0.05 | 0.09 | 0.14 | 0.21 | 0.41 | 0.65 | 0.85 | 0.99 | 1.09 | 1.11 | 1.13 | 1.14 |

The dynamic sensitivity was evaluated by comparing the optical density (O.D.) in the printing range from 9 to 21, wherein a high O.D. at the same printing energy indicated high sensitivity, corresponding to better quality.

In the energy range of 27 to 30, we can evaluate the maximum image density achievement, a high O.D. indicates a high maximum image density, providing a better image quality (darker image).

From the sample A0 (no sensitizer) to sample A4, it can be seen that OPTSA improves the dynamic sensitivity, and the higher the ratio of OPTSA, the higher the dynamic sensitivity, which is also the case for the maximum image density. This is seen even if a saturation starts to appear above the ratio 3.0 of OPTSA vs 2.0 of color developer.

PTSA (A5) & OTSA (A6) work also as sensitizer with the color developer Pergafast™ 425, but the mixture OPTSA (A2) shows a better dynamic sensitivity level. Results also indicate that combinations of OPTSA with other sensitizers or waxes improves the dynamic sensitivity as well, e.g., (Samples A1-1 to H1.

TABLE 4
Printer Energy - Results of Example 2

| | 0 | 2 | 4 | 6 | 9 | 12 | 15 | 18 | 21 | 24 | 27 | 30 |
|---|---|---|---|---|---|---|---|---|---|---|---|---|
| R1 | 0.06 | 0.07 | 0.09 | 0.16 | 0.31 | 0.53 | 0.76 | 0.94 | 1.09 | 1.16 | 1.22 | 1.24 |
| R2 | 0.07 | 0.12 | 0.19 | 0.34 | 0.57 | 0.85 | 1.03 | 1.14 | 1.20 | 1.24 | 1.25 | 1.26 |
| R3 | 0.05 | 0.05 | 0.06 | 0.07 | 0.11 | 0.22 | 0.35 | 0.55 | 0.72 | 0.83 | 0.96 | 0.99 |
| R4 | 0.05 | 0.07 | 0.10 | 0.18 | 0.39 | 0.60 | 0.83 | 1.00 | 1.08 | 1.13 | 1.18 | 1.18 |
| R5 | 0.05 | 0.07 | 0.10 | 0.18 | 0.40 | 0.65 | 0.92 | 1.08 | 1.13 | 1.20 | 1.24 | 1.24 |

Two different color developers were evaluated in this study without OPTSA sensitizer (R1 & R3) and with OPTSA as sensitizer (R2, R4, & R5). Results indicate that when OPTSA is used in combination with the two color developers there is a marked increase in dynamic sensitivity resulting in improved maximum image density.

### Example 3—Image & Background Stability

The Optical Density (O.D.) of the thermal printed image and background whiteness of the non-thermal printed area of the media were measured before and after exposure to ageing test.

The lower the gap of Optical Density (O.D.) between initial level and after ageing level, the higher the thermosensitive media stability and resistance. Table 5 below, summarizes the results of this study.

### Image Quality Evaluated by Optical Density (O.D.):

Using a direct thermal printer a ZEBRA™ ZT610 direct thermal printer with a 201 dpi flat thermal printing head (manufactured by ZEBRA Technologies Corp.), each heat-sensitive recording material was printed at an applied energy of 30, and at 200 minis and the density of the recorded image thus obtained was measured with a X-Rite/Densieye™ 700 (from X-Rite Europe GmbH) optical densitometer. The background quality was evaluated by Optical Density (O.D.):

The Optical Density (O.D.) of the unrecorded surface of the coated substrate was measured with an X-Rite/Densieye™ 700 (from X-Rite Europe GmbH) optical densitometer.

### Water Resistance:

After thermal printing, the coated substrate was immersed in de-ionized water at 40° C. for 24 Hrs.

After this treatment, the sample is maintained at room temperature during the time necessary to be completely dry. Then, the O.D. of the image and the background were measured using a X-Rite/Densieye™ 700 (from X-Rite Europe GmbH) optical densitometer.

Remaining Image ratio is evaluated according to the following calculation method:

Remaining ratio (%)=(O.D. after Water resistance test)/(O.D. of non-treated material)×100

### Plasticizer Face Resistance:

After thermal printing, the «Face side» of the coated substrate where the printed image is recorded, is put in close contact with a sheet of PVC wrapping film (containing phthalate ester-type plasticizer) from Jet Cut GmbH., under 50 g/cm-2 pressure for 15 Hrs at 40° C.

After this treatment, PVC film is removed from the face surface, and the sample is maintained at room temperature during 1 hr.

Then, the O.D. of the image and the background were measured using a X-Rite/Densieye™ 700 (from X-Rite Europe GmbH) optical densitometer, within 8 hrs after removal of the PVC film.

Remaining Image ratio was evaluated according to the following calculation method:

Remaining ratio (%)=(O.D. after Plasticizer Face resistance test)/(O.D. of non-treated material)×100

### Oil Resistance:

After thermal printing, 0.05 ml of virgin olive oil is applied uniformly onto the face side of the coated substrate and the sample is maintained at 25° C. for 24 hours.

After this treatment, the O.D. of the image and the background were measured using an X-Rite/Densieye™ 700 (from X-Rite Europe GmbH) optical densitometer.

The remaining image ratio was evaluated according to the following calculation method:

Remaining ratio (%)=(O.D. after Oil resistance test)/(O.D. of non-treated material)×100

### Heat Resistance:

After thermal printing, the coated substrate is placed in a dry oven at 80° C./90° C./100° C. for 1 Hour.

After this treatment, the sample is maintained at room temperature for 1 Hour. Then, the O.D. of the image and the background were measured using an X-Rite/Densieye™ 700 (from X-Rite Europe GmbH) optical densitometer.

Remaining Image ratio is evaluated according to the following calculation:

Remaining ratio (%)=(O.D. after Heat resistance test)/(O.D. of non-treated material)×100

### Example 4—Results of Image & Background Stability of Tested Thermosensitive Papers

### Light (Xenon Light) Resistance:

After thermal printing, the heat-sensitive recording material was stored for 4 Hrs in a Xenon weatherometer (Atlas Suntest CPS+WB 300-800 nm with a window glass filter/500 W−temperature maintained below 40° C.).

After this treatment, the O.D. of the image and the background were measured using an X-Rite/Densieye™ 700 (from X-Rite Europe GmbH) optical densitometer.

Remaining Image ratio is evaluated according to the following calculation:

Remaining ratio (%)=(O.D. after Oil resistance test)/(O.D. of non-treated material)×100

TABLE 5
Effect of Sensitizer Ratio

| | Water | | Heat | | Heat | | Heat | |
|---|---|---|---|---|---|---|---|---|
| | 40°/24 H | | 80°/1 H | | 90°/1 H | | 100°/1 H | |
| | OD | | OD | | OD | | OD | |
| Sample | rem % | BG | rem % | BG | rem % | BG | rem % | BG |
| A0 | 90% | 0.05 | 103% | 0.05 | 108% | 0.05 | 98% | 0.08 |
| A1 | 87% | 0.05 | 101% | 0.05 | 97% | 0.06 | 90% | 0.08 |
| A2 | 81% | 0.05 | 101% | 0.05 | 95% | 0.06 | 85% | 0.11 |
| A3 | 77% | 0.04 | 102% | 0.06 | 99% | 0.06 | 84% | 0.13 |
| A4 | 75% | 0.04 | 99% | 0.06 | 101% | 0.06 | 84% | 0.15 |

| | Xenon | | Plasticizer | | Olive oil | |
|---|---|---|---|---|---|---|
| | 500 W/4 H | | 40° C./15 H | | 25° C./24 H | |
| | OD | | OD | | OD | |
| Sample | rem % | BG | rem % | BG | rem % | BG |
| A0 | 72% | 0.06 | 65% | 0.04 | 86% | 0.06 |
| A1 | 61% | 0.08 | 61% | 0.05 | 85% | 0.06 |
| A2 | 58% | 0.11 | 59% | 0.04 | 85% | 0.05 |
| A3 | 50% | 0.12 | 88% | 0.04 | 84% | 0.05 |
| A4 | 57% | 0.11 | 93% | 0.04 | 98% | 0.04 |

It was found that printed & non-printed (BG) areas of the recording sheet had good stability and resistance when OPTSA was used as the sensitizer. When OPTSA was used as the sensitizer in the composition, there was improved resistance to thermal background fogging of the unprinted areas. Generally, a high proportion of sensitizer impacts badly background heat resistance.

In addition, resistance against plasticizer and oil was better when OPTSA was a component of the thermo-sensitive formulation. Finally, a high preservability level of color developers, e.g., Pergafast™ 425 was maintained when used in combination with OPTSA.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It being understood that various changes may be made in the function and arrangement of elements described in an exemplary embodiment without departing from the scope of the present disclosure as set forth in the appended claims.

What is claimed is:

1. A heat-sensitive recording composition comprising:
a) one or more color formers;
b) one or more color developers; and
c) at least one sensitizer comprising a mixture of ortho-toluenesulfonamide and para-toluenesulfonamide (OPTSA).

2. The recording composition according to claim 1, the at least one sensitizer has a ratio of ortho-toluenesulfonamides to para-toluenesulfonamides of from about 0.5:99.5 to about 99.5:0.5 based on dry weight of the OPTSA mixture.

3. The recording composition according to claim 1, wherein the at least one sensitizer is present in an amount of from about 0.1 to about 6 parts by dry mass per one part of the one or more color formers.

4. The recording composition according to claim 1, wherein the one or more color developers is chosen from phenolic color developers, non-phenolic color developers and combinations thereof.

5. The recording composition according to claim 4, wherein the one or more color developers is chosen from 5-(N-3-methylphenyl-sulfonylamido)-(N′,N″-bis-(3-methylphenyl)-isophthalic acid diamide, [3-(p-tolylsulfonylcarbamoylamino)phenyl]4-methylbenzenesulfonate, 2.4′-dihydroxydiphenylsulfone, 4.4′-dihydroxydiphenylsulfone, bis-(3-allyl-4-hydroxyphenyl) sulfone, 4-[4′-[(1′-methylethyloxy)phenyl]sulfonyl]phenol, 4-hydroxyphenyl 4-isoprooxyphenyl sulfone, N-{2-[(phenylcarbamoyl)amino]phenyl} benzenesulfonamide, phenol, 4-[[4-(2-propenlyloxy)phenyl]sulfonyl, 4-Hydroxy-4′benzyloxydiphenylsulfone, and 4.4′bis(N-carbamoyl-4-methylbenzenesulfonamide) diphenylmethane, 4.4′-sulfonylbis-polymer with 1.1′-oxybis[2-chloroethane], phenols, urea urethane compounds and combinations thereof.

6. The recording composition according to claim 1, wherein the one or more color formers is chosen from fluoran, phthalide, lactam, triphenylmethane, phenothiazine, spiropyran leuco dyes and combinations thereof.

7. The recording composition according to claim 6, wherein the one or more color formers is chosen from 2-anilino-3-methyl-6-diethylaminofluorane, 2-anilino-3-methyl-6-dibutylaminofluorane, 2-anilino-3-methyl-6-(methyl-N-isoamylamino)fluorine, 2-anilino-3-methyl-6-(N-ethyl-N-propylamino)fluorane, 2-anilino-3-methyl-6-di-n-amylaminofluorane, 2-anilino-3-methyl-6-(N-ethyl-N-ptolylamino)fluorane, 2-anilino-3-methyl-6-N-ethyl-N-sec-butylaminofluorane, 3-di-(n-pentylamino)-6-methyl-7-anilinofluorane, 3-(N-isoamyl-N-ethylamino)-6-methyl-7-anilinofluorane, 3-(N-n-hexyl-N-ethylamino)-6-methyl-7-anilinofluorane, 3-[N-(3-ethoxypropyl)-N-ethylamino]-6-methyl-7-anilinofluorane, 3-di-(n-butylamino)-7-2-chloroanilino)fluorane, 3-diethylamino-7-(2-chloroanilino)fluorane, 3-(N-cyclohexyl-N-methylamino)-6-methyl-7-anilinofluorane and combinations thereof.

8. The recording composition according to claim 1, further comprising at least one additive chosen from image stabilizers, sensitizers, fillers, binders, dispersants, antioxidants, anti-tack agents, antifoaming agents, light stabilizers, fluorescent brightening agents and combinations thereof.

9. A method of producing a heat sensitive recording material, said method comprising:
providing a substrate;
applying or depositing one or more layers of a heat-sensitive recording composition according to claim 1, on the substrate forming a heat-sensitive layer, thereby producing the heat sensitive recording material.

10. The method according to claim 9, wherein the substrate has one or more coatings on its surface and wherein the heat-sensitive recording composition is deposited onto the one or more coatings.

11. A recording sheet comprising:
a substrate;
a recording composition disposed on the substrate and comprising one or more color formers; one or more color developers; and at least one sensitizer comprising a mixture of ortho-toluenesulfonamide and para-toluenesulfonamides (OPTSA).

12. The recording sheet according to claim 11, the at least one sensitizer has a ratio of ortho-toluenesulfonamides to para-toluenesulfonamides of from about 0.5:99.5 to about 99.5:0.5 based on dry weight of the OPTSA mixture.

13. The recording sheet according to claim 12, wherein the at least one sensitizer is present in an amount of from about 0.1 to about 6 parts by dry mass per one part of the one or more color formers.

14. The recording sheet according to claim 11, wherein the one or more color developers is selected from phenolic color developers, non-phenolic color developers and combinations thereof.

15. The recording sheet according to claim 14, wherein the one or more of the color developers is selected from the group consisting of 5-(N-3-methylphenyl-sulfonylamido)-(N′,N″-bis-(3-methylphenyl)-isophthalic acid diamide and [3-(p-tolylsulfonylcarbamoylamino)phenyl]4-methylbenzenesulfonate, 2.4′-dihydroxydiphenylsulfone, 4.4′-dihydroxydiphenylsulfone, bis-(3-allyl-4-hydroxyphenyl)sulfone, 4-[4′-[(1′-methylethyloxy)phenyl]sulfonyl]phenol, 4-hydroxyphenyl 4-isoprooxyphenylsulfone, N-{2-[(phenylcarbamoyl)amino]phenyl} benzenesulfonamide, phenol, 4-[[4-(2-propenlyloxy)phenyl]sulfonyl, 4-Hydroxy-4′benzyloxydiphenylsulfone, and 4.4′bis(N-carbamoyl-4-methylbenzenesulfonamide) diphenylmethane, 4.4′-sulfonylbis-polymer with 1.1′-oxybis[2-chloroethane], phenols, urea urethane compounds and combinations thereof.

16. The recording sheet according to claim 11, wherein the one or more color formers are selected from the group consisting of fluoran, phthalide, lactam, triphenylmethane, phenothiazine, spiropyran leuco dyes and combinations thereof.

17. The recording sheet of claim 16, wherein the one more color formers is selected from the group consisting 2-anilino-3-methyl-6-diethylaminofluorane, 2-anilino-3-methyl-6-dibutylaminofluorane, 2-anilino-3-methyl-6-(methyl-N-isoamylamino)fluorine, 2-anilino-3-methyl-6-(N-ethyl-N-propylamino)fluorane, 2-anilino-3-methyl-6-di-n-amylaminofluorane, 2-anilino-3-methyl-6-(N-ethyl-N-ptolylamino)fluorane, 2-anilino-3-methyl-6-N-ethyl-N-sec-butylaminofluorane, 3-di-(n-pentylamino)-6-methyl-7-anilinofluorane, 3-(N-isoamyl-N-ethylamino)-6-methyl-7-anilinofluorane, 3-(N-n-hexyl-N-ethylamino)-6-methyl-7-anilinofluorane, 3-[N-(3-ethoxypropyl)-N-ethylamino]-6-methyl-7-anilinofluorane, 3-di-(n-butylamino)-7-2-chloroanilino)fluorane, 3-diethylamino-7-(2-chloroanilino)fluorane, and 3-(N-cyclohexyl-N-methylamino)-6-methyl-7-anilinofluorane, 6-methyl-7-anilinofluorane and combinations thereof.

18. The recording sheet according to claim 11, wherein the recording composition further comprises image stabilizers, sensitizers, fillers, binders, dispersants, antioxidants, anti-tack agents, antifoaming agents, light stabilizers, fluorescent brightening agents and combinations thereof.

19. The recording sheet according to claim 11, wherein the substrate has one or more coatings on its surface and wherein the heat-sensitive recording composition is deposited onto or applied to the one or more coatings.

20. The recording sheet according to claim 19, wherein one or more topcoat layers is applied to the heat-sensitive layer.
